(19) United States
(12) Patent Application Publication
(10) Pub. No.: US 2026/0368777 A1
(43) Pub. Date: Nov. 19, 2026

(54) PROMOTION CONTENT DISPLAY METHOD AND APPARATUS, COMPUTER DEVICE, READABLE STORAGE MEDIUM, AND PROGRAM PRODUCT

(71) Applicant: TENCENT TECHNOLOGY (SHENZHEN) COMPANY LIMITED, Shenzhen (CN)

(72) Inventors: Xiaowen LIANG, Shenzhen (CN); Yonghong WANG, Shenzhen (CN)

(73) Assignee: TENCENT TECHNOLOGY (SHENZHEN) COMPANY LIMITED, Shenzhen (CN)

(21) Appl. No.: 19/723,655

(22) Filed: Jun. 29, 2026

Related U.S. Application Data
(63) Continuation of application No. PCT/CN2025/086490, filed on Apr. 1, 2025.

(30) Foreign Application Priority Data
May 31, 2024 (CN) 202410707111.X

(51) Int. Cl. G06Q 30/0242; G06F 3/0485

(52) U.S. Cl. CPC G06Q 30/0244; G06F 3/0485

(57) ABSTRACT

A method for promotion content display performed by a terminal includes displaying an information flow interface including a plurality of content positions, each of the plurality of content positions being configured to display a content cover of one multimedia content; and displaying, through at least two of the plurality of content positions based on a promotion content presentation condition being met, a linked promotion content configured to promote a target object, each of the at least two of the plurality of content positions displaying a local promotion content of the linked promotion content.

### CROSS-REFERENCE TO RELATED APPLICATION

This application is a bypass continuation application of International Patent Application No. PCT/CN2025/086490, filed on Apr. 1, 2025, which claims priority to and is based on Chinese Patent Application No. 202410707111.X, filed on May 31, 2024, the disclosures of which are incorporated herein in their entireties by reference

### FIELD

Some embodiments of the present disclosure relate to the technical field of information processing, and in particular, to a promotion content display method and apparatus, a computer device, a computer-readable storage medium, and a computer program product.

### BACKGROUND

Promotion contents may be in different forms (e.g., splash screen promotion content, an interstitial promotion content, an information flow promotion content, a banner promotion content) and maybe presented by an interface (e.g., graphical user interface (GUI)). However, if the position where the promotion content is too small or otherwise restricted, there might be difficulties in clearly presenting the promotion contents, thereby causing waste in computing resources used to display the interface. Displaying the promotion content can be improved.

Information disclosed in this Background section was either known to the inventors before achieving the present disclosure or represents technical information acquired during the development process. Therefore, it may contain information that does not constitute prior art known to the public.

### SUMMARY

Some embodiments of the present disclosure provide a promotion content display method and apparatus, a computer device, a computer-readable storage medium, and a computer program product.

According to some embodiments of the present disclosure, a method for promotion content display performed by a terminal includes displaying an information flow interface including a plurality of content positions, each of the plurality of content positions being configured to display a content cover of one multimedia content; and displaying, through at least two of the plurality of content positions based on a promotion content presentation condition being met, a linked promotion content configured to promote a target object, each of the at least two of the plurality of content positions displaying a local promotion content of the linked promotion content.

According to some embodiments of the present disclosure, an apparatus for promotion content display includes at least one memory configured to store computer program code and at least one processor configured to read the program code and operate as instructed by the program code. The program code includes interface presentation code configured to cause the at least one processor to display an information flow interface including a plurality of content positions, each of the plurality of content positions being configured to display a content cover of one multimedia content; and content presentation code configured to cause the at least one processor to display, through at least two of the plurality of content positions based on a promotion content presentation condition being met, a linked promotion content configured to promote a target object, each of the at least two of the plurality of content positions displaying a local promotion content of the linked promotion content.

According to some embodiments of the present disclosure, a non-transitory computer-readable storage medium, storing computer program code, when executed by at least one processor, causes the at least one processor to at least, display an information flow interface including a plurality of content positions, each of the plurality of content positions being configured to display a content cover of one multimedia content; and display, through at least two of the plurality of content positions based on a promotion content presentation condition being met, a linked promotion content configured to promote a target object, each of the at least two of the plurality of content positions displaying a local promotion content of the linked promotion content.

Details of some embodiments of present disclosure are provided in the following accompanying drawings and descriptions. Other features, objectives, and advantages of present disclosure become apparent from the present disclosure, the accompanying drawings, and the claims.

### BRIEF DESCRIPTION OF THE DRAWINGS

The above and other aspects, features, and advantages of one or more embodiments of the present disclosure will be more apparent from the following description taken in conjunction with the accompanying drawings, in which:

FIG. 1 is a diagram of an application environment of a promotion content display method according to some embodiments;

FIG. 2 is a schematic flowchart of a promotion content display method according to some embodiments;

FIG. 3A is a schematic diagram of an information flow interface according to some embodiments;

FIG. 3B is a schematic diagram of an information flow interface according to some embodiments;

FIG. 4 is a schematic diagram of an information flow interface according to some embodiments;

FIG. 5 is a schematic diagram of an information flow interface according to some embodiments;

FIG. 6 is a schematic diagram of an information flow interface according to some embodiments;

FIG. 7 is a schematic diagram of an information flow interface according to some embodiments;

FIG. 8 is a schematic diagram of an information flow interface according to some embodiments;

FIG. 9 is a schematic diagram of an information flow interface according to some embodiments;

FIG. 10 is a schematic diagram of an information flow interface according to some embodiments;

FIG. 11 is a schematic diagram of a target linked special effect according to some embodiments;

FIG. 12 is a schematic diagram of a target linked element according to some embodiments;

FIG. 13 is a schematic diagram of a promotion content presentation region according to some embodiments;

FIG. 14 is a schematic diagram of a mask layer according to some embodiments;

FIG. 15 is a schematic diagram of a target information flow according to some embodiments;

FIG. 16 is a schematic diagram of a target information flow according to some embodiments;

FIG. 17 is a structural block diagram of a promotion content display apparatus according to some embodiments; and

FIG. 18 is an internal structural diagram of a computer device according to some embodiments;

### DETAILED DESCRIPTION

Technical solutions in some embodiments of the present disclosure are clearly and completely described below with reference to accompanying drawings in some embodiments of present disclosure. Some embodiments are merely some rather than all of some embodiments of present disclosure. All other embodiments obtained by a person of ordinary skill in the art based on some embodiments of present disclosure without creative efforts shall fall within the protection scope of present disclosure.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Terms such as “set” (e.g., “a set of items”) or “subset” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

An expression, “a and/or b” may be understood as including only a, only b and both a and b. Expressions “at least one of a, b, and c” and “at least one of a, b, or c” may be understood as including only a, only b, only c, both a and b, both a and c, both b and c, or all of a, b, and c. Also, expressions such as ‘a, b, or c’ may be understood as ‘at least one of a, b, or c’ unless explicitly stated otherwise, or unless the elements would only be understood as alternatives by a person ordinarily skilled in the art.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

With regard to the description of the drawings, similar reference numerals may be used to refer to similar or related components.

The term, involved in the following description, “some embodiments” describes subsets of all possible embodiments, but “some embodiments” may be the same subset or different subsets of all the possible embodiments and may be combined with each other without conflict.

The operations, techniques, and processes described herein may be implemented via executable instructions or computer program code stored on computer-readable medium. Such computer program code may include distinct portions or modules, where each portion comprises a subset of the total instructions to perform specific operations.

Throughout the present disclosure, terms such as ‘is’ and ‘are’ may be used to describe certain characteristics, components, or steps of some embodiments. Such language is utilized merely for the sake of clarity and illustrative convenience to describe specific examples, and is intended to be interpreted as exemplary rather than limiting. Unless expressly stated otherwise, any feature described with such language should be understood as optional, and interpreted as though modified by permissive terms such as “may,” “can,” “could,” or “might.”

A promotion content is indispensable to a content service in an Internet life of people. To prevent a promotion content from causing an adverse impression of a user, a native creative appears, namely, the promotion content is integrated into a product form, so that the user is unconsciously exposed to a promotion product, thereby generating a favorable impression. The promotion content generated through the native creative is a native promotion content, and the native promotion content can be naturally integrated with a surrounding content.

For example, in an interface configured for presenting a push content, the promotion content is usually presented in a presentation region in the interface. However, if the presentation region has an excessively small space, a presentation space is cramped, features of a promoted product cannot be maximally presented, and the promotion content has a poor display effect.

However, in the promotion content display method provided in present disclosure, an information flow interface is displayed, the information flow interface includes a plurality of content positions, and each of the content positions is configured for displaying a content cover of one multimedia content. In this way, more real-time multimedia content can be provided for the user based on the plurality of content positions in the information flow interface, ensuring pushing efficiency and timeliness of the multimedia content. In response to the promotion content presentation condition being met, the linked promotion content configured for promoting the target object is jointly displayed through at least two of the plurality of content positions. The linked promotion content is configured for promoting the target object. In this way, the linked promotion content is naturally integrated into an interface configured for promoting the multimedia content, a native format is maintained, and user experience is ensured. Each of the at least two content positions displays a local promotion content of the linked promotion content. In some examples, the target object is jointly promoted in the information flow interface in combination with the plurality of content positions, so that features of the target object can be maximally presented, and the display effect of the promotion content is improved.

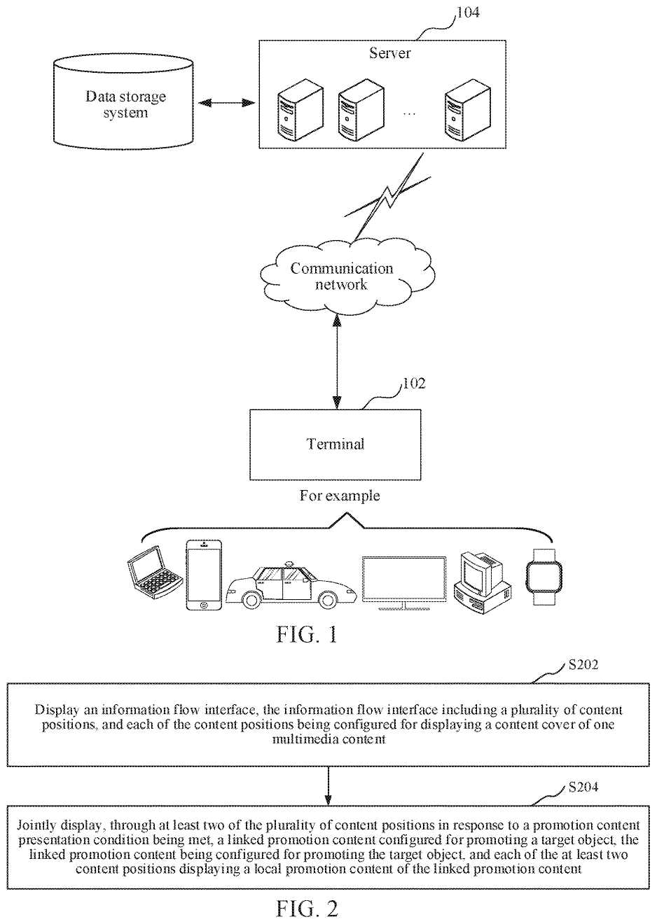

A promotion content display method provided in some embodiments of present disclosure may be applied to an application environment shown in FIG. 1. In the figure, a terminal 102 communicates with a server 104 through a network. A data storage system may store data that needs to be processed by the server 104. The data storage system may be integrated on the server 104, or may be deployed on a cloud or another server. The terminal 102 displays an information flow interface, where the information flow interface includes a plurality of content positions, and each of the content positions is configured for displaying a content cover of one multimedia content. The content cover of the multimedia content displayed in each content position is obtained by the terminal 102 by generating a content push request to the server 104 in response to an operation that is triggered on the information flow interface and that is related to requesting a content push, and the server 104 determines content covers of a plurality of multimedia contents based on the content push request, and returns the content covers to the terminal 102.

The terminal 102 jointly displays, through at least two content positions in the plurality of content positions in response to a promotion content presentation condition being met, the linked promotion content configured for promoting the target object. The linked promotion content is configured for promoting the target object, and each of the at least two content positions displays a local promotion content of the linked promotion content.

The terminal 102 may be, but is not limited to, various personal computers, notebook computers, smart phones, tablet computers, Internet of Things devices and portable wearable devices. The Internet of Thing device may be a smart television, a smart air conditioner, a smart in-vehicle device, a projection device, or the like. The portable wearable device may be a smart watch, smart bracelet, or the like. The server 104 may be an independent physical server, or may be a server cluster composed of a plurality of physical servers or a distributed system, and may further be a cloud server providing a cloud computing service.

One or more components of FIG. 1 may be integrated into a single component, or conversely, a single component may be implemented as multiple discrete elements. Additionally or alternatively, different subsets of the illustrated components may be combined in various configurations.

In some embodiments, as shown in FIG. 2, a promotion content display method is provided. A description is provided by using an example that the method is applied to the terminal 102 in FIG. 1. The method includes operation S202 to operation S204 described below. Specifically,

Operation S202: Display an information flow interface, the information flow interface including a plurality of content positions, and each of the content positions being configured for displaying a content cover of one multimedia content.

The information flow interface is an interface configured for presenting a multimedia content, and the information flow interface may be an interface for presenting the multimedia content in a waterfall flow layout. The waterfall flow layout usually arranges the multimedia content in an arrangement form of a plurality of rows and a plurality of columns, which is visually manifested as uneven, like a flowing waterfall.

The content position refers to a region of a content cover configured for presenting the multimedia content. In some embodiments, a size of each content position may be the same, or may be different. This is not specifically limited. Operations may be performed sequentially, in a different order, in parallel, or with some operations skipped or repeated.

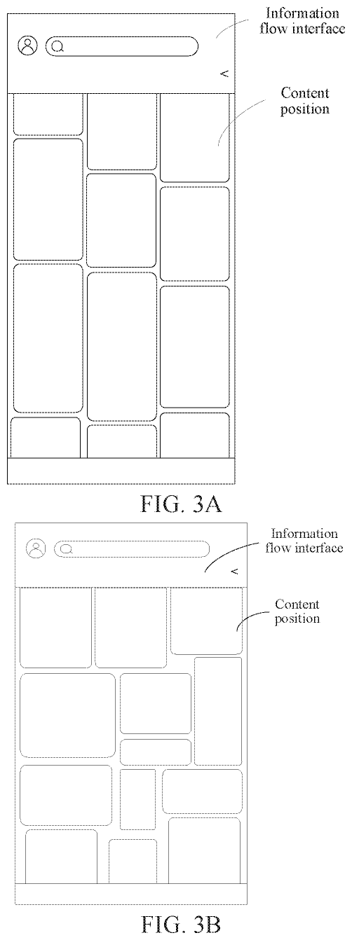

For example, FIG. 3A is a schematic diagram of an information flow interface according to some embodiments. In FIG. 3A, the information flow interface has 3 columns, each column includes a plurality of content positions, and the content positions are arranged in a staggered manner, resembling a flowing waterfall.

For another example, FIG. 3B is a schematic diagram of an information flow interface according to some embodiments. In FIG. 3B, the information flow interface has 3 columns. Content positions of different sizes exist in the information flow interface, and content positions of different widths also exist. The content positions are arranged in a staggered manner, also resembling a flowing waterfall.

The multimedia content is a content pushed to a user for presentation. The multimedia content includes, but is not limited to, a video, a picture, an audio and video, an article, and a graphic and text. The content cover of the multimedia content is a material configured for advertising the multimedia content, and may be, for example, a text, a picture, or a graphic and text. The content cover of the multimedia content may be information in the multimedia content, or may be information that originates outside the multimedia content.

In some embodiments, after logging into a user-generated content client with a current login account, the terminal presents the information flow interface. Each content position in the information flow interface is configured for presenting a content cover of one corresponding multimedia content. The user-generated content client is a client, for example, a social client, an instant messaging client, or an e-commerce client, by which a user creates original content and publishes the original content.

Referring to FIG. 3A, the information flow interface has 12 content positions, and each of the content positions is configured for presenting a content cover of one multimedia content. In some examples, a current information flow interface may present content covers of 12 multimedia contents. A content detail interface is switched to in response to a triggering operation performed on any content cover, and the content detail interface is configured for presenting a multimedia content corresponding to any content cover.

Operation S204: Jointly display, through at least two of the plurality of content positions in response to a promotion content presentation condition being met, a linked promotion content configured for promoting a target object, the linked promotion content being configured for promoting the target object, and each of the at least two content positions displaying a local promotion content of the linked promotion content.

The target object is an object to be promoted in the information flow interface. The target object may be a commodity, a video, an audio, or the like.

The linked promotion content is a promotion content of linked promotion on the target object in a plurality of content positions in the information flow interface. The linked promotion content occupies at least two adjacent content positions. One target object is presented by using the at least two content positions. For example, a presentation form of the linked promotion content may be a picture, a video, or a graphic and text. This is not limited. The promotion content may be an advertisement, and the linked promotion content may be a linked advertisement.

A content displayed in each of the at least two adjacent content positions is the local promotion content. A presentation form of the local promotion content may be a picture, a video, or a graphic and text. This is not limited. The local promotion content respectively displayed in at least two adjacent content positions jointly form the linked promotion content.

For example, jointly forming may refer to a process of orderly splicing the local promotion contents based on continuity between the local promotion contents.

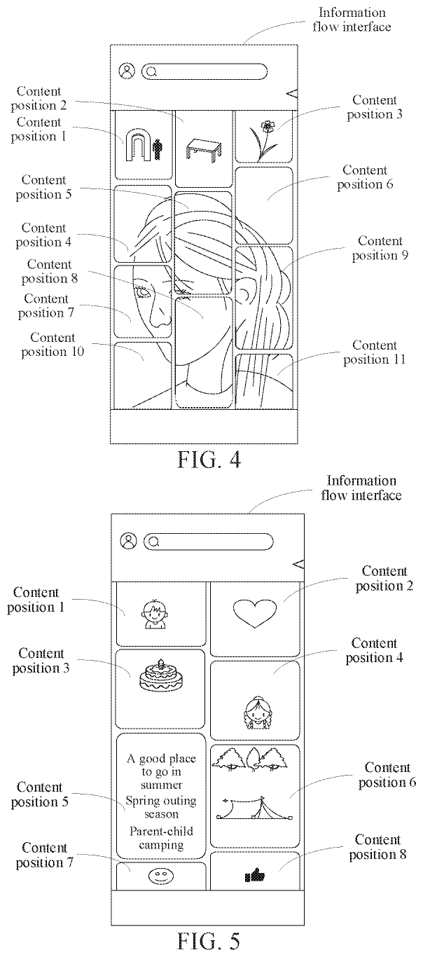

FIG. 4 is a schematic diagram of an information flow interface according to some embodiments. The information flow interface includes 11 content positions, where a content position 1 to a content position 3 respectively present content covers of a multimedia content 1, a multimedia content 2, and a multimedia content 3. The target object is a target comic, each local promotion content of a content position 4 to a content position 11 is in a picture form, and each local promotion content of the two adjacent content positions is continuous.

For example, jointly forming may also be a process of arranging each local promotion content based on a preset arrangement manner. For example, FIG. 5 is a schematic diagram of an information flow interface according to some embodiments. In the information flow interface, content covers of 6 multimedia contents are respectively presented in a content position 1 to a content position 4 and a content position 7 to a content position 8. In some examples, the information flow interface further displays a linked promotion content in which a target article is a tent. The linked promotion content includes local promotion contents respectively corresponding to a content position 5 and a content position 6. A local promotion content 1 in the content position 5 represents a use scenario of the tent in a form of a text, and a local promotion content 2 in the content position 6 represents a form of the tent in a form of the picture. The linked promotion content configured for promoting the tent is formed by using the local promotion content 1 and the local promotion content 2 in different representation forms.

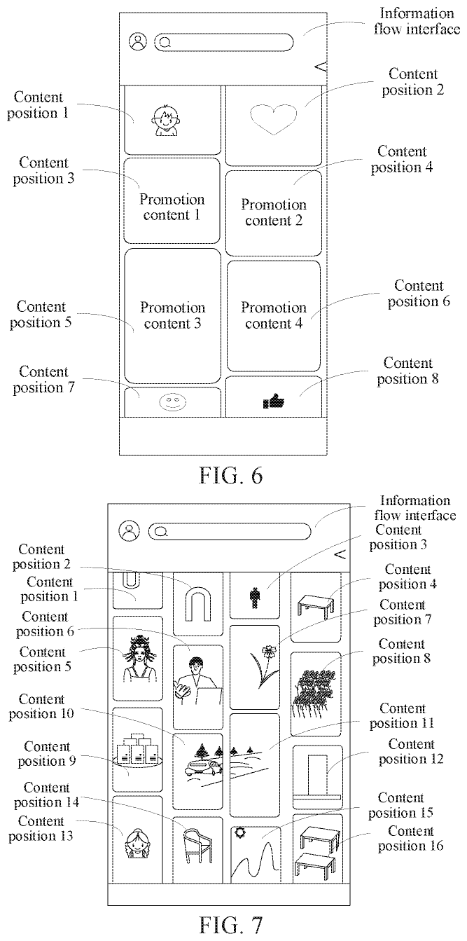

For another example, FIG. 6 is a schematic diagram of an information flow interface according to some embodiments. In the information flow interface, content covers of 4 multimedia contents are respectively presented in a content position 1 to a content position 2 and a content position 7 to a content position 8. The local promotion contents in the content positions 3 to 6 jointly form a linked promotion content about a beverage. For ease of selection by the user, promotion contents of different purchase links are provided, and corresponding promotion contents are presented in different local promotion contents. The local promotion content in the content position 3 presents a promotion content 1 (a price of purchasing one box of the beverage at a time), the local promotion content in the content position 4 presents a promotion content 2 (a price of purchasing two boxes of the beverage at a time), the local promotion content in the content position 5 presents a promotion content 3 (a price of purchasing three boxes of the beverage at a time), and the local promotion content in the content position 6 presents a promotion content 4 (a price of purchasing four boxes of the beverage at a time). The four local promotion contents jointly form a linked promotion content configured for promoting the beverage.

Meeting a promotion content presentation condition refers to a condition allowing the target object to be promoted. For example, the promotion content presentation condition may be that a preset triggering operation is detected, a browsing duration reaches a set threshold, user description data matches an object attribute of the target object, or user operation data (for example, browsing data) matches the object attribute of the target object. This is not limited.

In some embodiments, during presenting content covers of a plurality of multimedia contents in the information flow interface, in response to that a promotion content presentation condition about the target object is met, a terminal displays the linked promotion content of the target object in the information flow interface. The linked promotion content occupies at least two adjacent content positions, and the local promotion contents displayed in each of the at least two content positions jointly form the linked promotion content.

The linked promotion content may be a complete promotion content, or may be a part of the complete promotion content.

For example, after each time a preset quantity of content covers of multimedia contents are presented, the terminal determines that the promotion content presentation condition is met, and presents the linked promotion content in the information flow interface. For example, the promotion content presentation condition about the target object is a frequency of 30, namely, each time content covers of 30 multimedia contents are presented, one linked promotion content of the target object is presented.

In some embodiments, a content width of the linked promotion content is equal to an interface width of the information flow interface.

For example, content positions in the same column in the information flow interface have the same width, or each content position in the information flow interface has the same width.

Referring to FIG. 4, the linked promotion content is spliced from the local promotion contents of the content position 4 to the content position 11. In the layout of the information flow interface, each column of content positions has the same width, and a quantity of content positions that the linked promotion content transversely spans is the same as a quantity of content positions that are fully transversely displayed in the information flow interface (there are 3 columns). In a horizontal direction, the content width of the linked promotion content is composed of a sum of the widths of the content position 4 to the content position 6 (which are some content positions presented horizontally, and may represent a horizontal span thereof), and the interface width of the information flow interface is also a sum of widths of 3 parallel content positions. Therefore, the content width of the linked promotion content is equal to the interface width of the information flow interface, and it is equivalent to that a linked promotion content having a full width is presented in the information flow interface.

Certainly, in some other examples, the content width of the linked promotion content may be less than the interface width of the information flow interface. In this case, the content cover of the multimedia content is presented around the linked promotion content.

FIG. 7 is a schematic diagram of an information flow interface according to some embodiments. Different content covers are presented in content positions 1 to 9 and content positions 12 to 16 in the information flow interface in FIG. 7, and content positions 10 to 11 are respectively the local promotion content 1 and the local promotion content 2. The local promotion content 1 and the local promotion content 2 jointly form the linked promotion content, and the content width of the linked promotion content is less than the interface width of the information flow interface.

In this embodiment, by ensuring that the content width of the linked promotion content is equal to the interface width of the information flow interface, the linked promotion content can be more naturally integrated into the information flow interface for presenting the multimedia content, so that the format of the information flow interface before and after the linked promotion content is inserted into the information flow interface is not much different, In some examples, the native format is maintained, thereby ensuring browsing experience of the user.

In some embodiments, the jointly displaying, through at least two of the plurality of content positions in response to a promotion content presentation condition being met, a linked promotion content configured for promoting a target object includes: jointly displaying, through at least two of the plurality of content positions in response to triggering a sliding operation performed on the information flow interface, the linked promotion content configured for promoting the target object.

For example, the sliding operation is a sliding operation of sliding toward a preset direction. For example, the preset direction is the same as a sliding direction of the sliding operation triggering displaying of the content cover. For example, after the user slides up to update the content cover of the multimedia content, the user continues to slide up, and the linked promotion content is displayed in the information flow interface. In this embodiment, when the user habitually performs a sliding-down operation on the information flow interface to browse more content, the system detects the sliding operation and that a promotion content presentation condition is met, so that the linked promotion content is jointly presented by at least two content positions. This manner conforms to daily operation habits of the user, and can naturally present the promotion content to the user.

In this embodiment, displaying of the linked promotion content can be triggered more conveniently through a sliding operation, thereby improving user experience.

In some embodiments, the jointly displaying, through at least two of the plurality of content positions in response to a promotion content presentation condition being met, a linked promotion content configured for promoting a target object includes: jointly displaying, through at least two of the plurality of content positions in response to triggering the sliding operation performed on the information flow interface, a linked promotion content that is configured for promoting the target object and matches a sliding speed of the sliding operation, different sliding speed ranges matching linked promotion contents configured for promoting different types of target objects.

For example, a mapping relationship between a sliding speed and a type of an object is preset. In response to triggering a sliding operation performed on the information flow interface, a sliding speed of the sliding operation is determined, and an object of a corresponding type is determined based on the mapping relationship. A linked promotion content of the object of the type is obtained, and the obtained linked promotion content is displayed in the information flow interface. For example, in response to a sliding operation triggered on the information flow interface, a sliding speed and a sliding direction of the sliding operation are determined. In a case in which it is verified that the sliding direction is the preset direction, returning to the operation of determining the sliding speed of the sliding operation and continuing to be performed.

In this embodiment, the linked promotion content that is configured for promoting the target object and matches a sliding speed of the sliding operation is jointly displayed through at least two of the plurality of content positions in response to triggering the sliding operation performed on the information flow interface, and different sliding speed ranges match linked promotion contents configured for promoting different types of target objects. In some examples, the matched linked promotion content is displayed in real time based on the sliding speed, thereby improving flexibility of display of the promotion content.

In some embodiments, the jointly displaying, through at least two of the plurality of content positions in response to a promotion content presentation condition being met, a linked promotion content configured for promoting a target object includes: jointly displaying, by sliding to at least two of the content positions in a current display region in response to triggering the sliding operation performed on the information flow interface, a linked promotion content that is configured for promoting the target object and matches typesetting information of the content positions in the current display region, different typesetting information being correspondingly configured for promoting linked promotion contents of different types of objects.

For example, in response to triggering the sliding operation performed on the information flow interface, a picture of a current display region to which the current information flow interface slides is clipped, picture recognition is performed on the picture, and typesetting information of a content position in the current display region is recognized. An object matching the typesetting information is determined based on a preset mapping relationship between typesetting information and a type of an object, the linked promotion content of the object is obtained, and the linked promotion content is presented in the information flow interface.

For example, after the object matching the typesetting information is determined, a selection list of the linked promotion content corresponding to the object is presented in the information flow interface. The selection list includes a plurality of candidate linked promotion content of the object, and quantities of content positions occupied by each candidate linked promotion content are different. In response to a selection operation performed on any one of the candidate linked promotion contents in the selection list, the selected candidate linked promotion content is presented in the information flow interface.

For example, the object is a fruit, and a candidate linked promotion content 1 and a candidate linked promotion content 2 exist. The candidate linked promotion content 1 occupies 3 content positions and is a horizontal version. The candidate linked promotion content 2 occupies 6 content positions, and is a vertical version. If the candidate linked promotion content 1 is selected through the current login account, the candidate linked promotion content 1 is presented in the information flow interface.

In some examples, after the object matching the typesetting information is determined, based on a browsing habit of a current login account, a candidate linked promotion content corresponding to the browsing habit is determined from a plurality of candidate linked promotion contents.

In this embodiment, the linked promotion content that is configured for promoting the target object and matches typesetting information of the content positions in the current display region is jointly displayed by sliding to at least two of the content positions in a current display region in response to triggering the sliding operation performed on the information flow interface, and different typesetting information are correspondingly configured for promoting linked promotion contents of different types of objects. In some examples, a proper linked promotion content is laid out by consideration of a typesetting dimension, to ensure that the linked promotion content can be integrated into the information flow interface more naturally, thereby improving a display effect of the promotion content.

In some embodiments, before the jointly displaying, through at least two of the plurality of content positions in response to a promotion content presentation condition being met, a linked promotion content configured for promoting a target object, the method further includes: continuously displaying new content positions in the information flow interface with a sliding direction of the sliding operation in response to the sliding operation triggered on the information flow interface, and displaying a content cover of one loaded multimedia content in each new content position, the multimedia content being issued through a multimedia account.

The sliding operation is configured for updating content in the information flow interface, and the content may be a multimedia content, or may be a linked promotion content. The sliding direction is a direction of a content cover configured for loading a new multimedia content, and may be from the top to the bottom of the information flow interface, or may be from the bottom to the top of the information flow interface, or may be from the left to the right of the information flow interface, or may be from the right to the left of the information flow interface.

The multimedia account is an account issuing a multimedia content. The multimedia account may be an account followed by a current login account, or may be an account not followed by a current login account.

For example, in response to a sliding operation triggered on the information flow interface, the terminal continuously displays and presents a preset quantity of new content positions in the information flow interface based on a sliding direction of the sliding operation, and displays a content cover of one loaded multimedia content in each new content position. The preset quantity matches sliding amplitude of the sliding operation. A larger sliding amplitude, for example, a larger sliding down amplitude, indicates a larger preset quantity.

In this embodiment, through a sliding operation performed on the information flow interface, new content positions are continuously loaded in real time. In this way, a multimedia content issued through a corresponding multimedia account is presented in real time based on each new content position, ensuring that a user can obtain the multimedia content in time and conveniently.

In some embodiments, a display sequence of the local promotion contents respectively displayed in the at least two content positions is the same as an exposure sequence of the at least two content positions. The jointly displaying, through at least two of the plurality of content positions in response to a promotion content presentation condition being met, a linked promotion content configured for promoting a target object includes: obtaining an exposure sequence of at least two content positions occupied by the linked promotion content; and sequentially displaying, in response to a promotion content presentation condition being met, a corresponding local promotion content in each of the at least two content positions in the information flow interface based on the exposure sequence of the at least two content positions.

The exposure sequence of the content positions may be understood as a sequence in which the content positions are presented in the information flow interface.

The exposure sequence of the at least two content positions determines a presentation manner of the linked promotion content in the information flow interface.

For example, the exposure sequence of the at least two content positions is determined based on a browsing habit of the current login account. For example, if the browsing habit is from top to bottom, the exposure sequence is that exposure sequences of a plurality of content positions in the same rank are the same. A larger rank number of content indicates a later exposure sequence. Referring to FIG. 4, if the exposure sequence is: first, the content position 4 to content position 6 are simultaneously exposed, then the content position 7 to content position 9 are simultaneously exposed, and finally the content position 10 to content position 11 are simultaneously exposed, the linked promotion content is presented from top to bottom.

For example, a key content position of a key local promotion content in the linked promotion content is determined, the key content position is used as a first content position for exposure, and an exposure sequence of a content position closer to the key content position in at least two content positions is closer by using the key content position as a center. In this way, the exposure sequence of the at least two content positions is determined. The key content position may be a content position at which the local promotion content with more detailed information about the target object is located. For example, when an electronic product is promoted, a content position at which the local promotion content presenting a core technical parameter and internal construction details of the product is located may be set as the key content position. Certainly, the key content position may also be determined based on a requirement, for example, based on a service key. If a use scenario of a product is more emphasized in the current promotion, the content position at which the local promotion content presenting rich use scenario information is located may be used as the key content position. In this embodiment, the corresponding local promotion contents in each of the at least two content positions in the information flow interface are sequentially displayed based on the exposure sequence of the at least two content positions in response to a promotion content presentation condition being met, to gradually display the linked promotion content, thereby improving user experience.

In some embodiments, the at least two content positions include a center content position located in a middle position and an outer content position surrounding the center content position. The jointly displaying, through at least two of the plurality of content positions in response to a promotion content presentation condition being met, a linked promotion content configured for promoting a target object includes: displaying that the linked promotion content in the center content position is gradually enlarged until the outer content position of the at least two content positions is occupied after the linked promotion content is displayed in the center content position of the at least two content positions in response to the promotion content presentation condition being met.

For example, in response to a promotion content presentation condition being met, after the linked promotion content is displayed in a center content position of the at least two content positions and the cover content of the multimedia content is displayed in the outer content positions, the updating suspension condition in the information flow interface is met, and that the linked promotion content in the center content position is gradually enlarged is displayed until the enlarged linked promotion content occupies the outer content positions.

That the updating suspension condition in the information flow interface is met may be that no sliding operation is received within a preset duration, or a selection operation on the center content position is received.

For example, the displaying the linked promotion content in the center content position is gradually enlarged, until the enlarged linked promotion content occupies the outer content positions includes: determining a sequence in which the outer content positions are occupied in a gradual enlarging process.

For a first occupied first outer content position, new content corresponding to the first occupied first outer content position is generated based on the linked promotion content displayed in the center content position, and the new content is displayed in the first outer content position. The linked promotion content obtained through a first enlarging is jointly formed based on the new content and the linked promotion content displayed in the center content position.

For each non-first occupied outer content position, new content associated with the non-first occupied outer content position is generated based on the linked promotion content obtained through previous enlarging, and the new content is presented in a current external content position. The linked promotion content obtained through a current enlarging is jointly formed based on the linked promotion content obtained through the previous enlarging and the new content, until the linked promotion content obtained through a last enlarging is determined.

For another example, the target promotion content is generated based on a quantity of the outer content positions, typesetting information of the outer content position located at a center content position, and the linked promotion content displayed at the center content position, and new content displayed in each outer content position is determined. The linked promotion content at the center content position and the new contents respectively displayed in the outer content positions jointly form the target promotion content.

A sequence in which the outer content positions are occupied in a gradual enlarging process is determined, and new contents in the outer content positions are gradually displayed until all the outer content positions display corresponding new contents.

Referring to FIG. 7, the at least two center content positions include content positions 5 to 16, the center content position is a content position 10, and the linked promotion content displayed in the content position 10 is a presentation vehicle. In this case, when the updating suspension condition in the information flow interface is met (for example, no sliding operation is received within a preset duration, or a selection operation performed on the center content position 10 is received), the current login account is interested in the vehicle presented in the content position 10. When an enlarging sequence of the content position is determined, in consideration of a layout of content positions and relevance to the content presented in the center content position 10, a content position 11 that is adjacent to and that is highly associated with the content position 10 is first occupied to present a new content that is related to the content position 10 and that has continuity, for example, a road in front of the vehicle. The new content in the content position 11 and the content position 10 jointly form the linked promotion content currently obtained through the enlarging. Then, a content position 12 (continuing to present an environment around the vehicle), a content position 16 (presenting a related scenario around the vehicle from another view of angle), a content position 15 (further adding related details), a content position 14 (continuously presenting the scenario around the vehicle), a content position 13 (continuing presentation logic), a content position 9 (regressing another part related to the vehicle in the overall layout), a content position 5 (a part associated with the overall vehicle promotion layout), a content position 6 (presenting another element related to the vehicle), 7 (enriching presentation content from different views), and a content position 8 are sequentially selected based on the relevance to a vehicle presentation theme and a spatial position proximity, until the enlarged linked promotion content occupies the content position 5 to the content position 16.

In this embodiment, that the linked promotion content in the center content position is gradually enlarged is displayed until the outer content position of the at least two content positions is occupied after the linked promotion content is displayed in the center content position of the at least two content positions in response to the promotion content presentation condition being met. In this way, dynamic enlarging of the linked promotion content can be implemented, to present details of the target object in a more flexible manner, thereby improving a presentation effect of the promotion content.

In some embodiments, the at least two content positions include a first content position subset and a second content position subset. The jointly displaying, through at least two of the plurality of content positions in response to a promotion content presentation condition being met, a linked promotion content configured for promoting a target object includes: displaying the linked promotion content in a content position in the first content position subset in response to the promotion content presentation condition being met, and displaying that the linked promotion content in the first content position subset is gradually moved from the first content position subset to a content position in the second content position subset.

The first content position subset includes at least one content position. Each first content position in the first content position subset displays the same content type. For example, the first content position subset is configured for presenting the linked promotion content, and the local promotion contents respectively displayed in first content positions in the first content position subset jointly form the linked promotion content.

The second content position subset includes at least one content position. Each second content position in the second content position subset displays the same content type, and content types respectively displayed by the second content position subset and the first content position subset are different. Continuing the foregoing example, correspondingly, the second content subset is configured for presenting the cover content, and each second content position in the second content subset is configured for displaying the content cover of the multimedia content.

For example, the linked promotion content is displayed in content positions in the first content position subset in response to the promotion content presentation condition being met. In response to that a movement condition of the linked promotion content is met, that the linked promotion content in the first content position subset is gradually moved from the first content position subset to content positions in the second content position subset is displayed, and that the cover contents in the second content position subset is gradually moved from the second content position subset to the content positions in the first content position subset is displayed.

That the movement condition of the linked promotion content is met may be that a duration for which the linked promotion content is displayed in the content position in the first content position subset reaches a preset duration. In some examples, a new sliding operation or the like may not be received.

Referring to FIG. 5, the first content position subset includes the content position 5 and the content position 6; and the second content position subset includes the content position 3 and the content position 4. The content position 5 and the content position 6 respectively display the local promotion content 1 and the local promotion content 2, and the content position 3 and the content position 4 respectively display a content cover 3 and a content cover 4. The movement condition of the linked promotion content is met (for example, the duration for which the linked promotion content is displayed in the content position in the first content position subset reaches the preset duration, or the new sliding operation is not received). In this case, to increase a dynamic presentation effect of the promotion content, attract user attention, and implement interaction between the content covers and the linked promotion content, the local promotion content 1 and the local promotion content 2 are respectively displayed in the content position 3 and the content position 4, and the content cover 3 and the content cover 4 are respectively displayed in the content position 5 and the content position 6. Through the transposition display, the user has a more intuitive feeling about the association between the promotion content and the multimedia content, and the display effect of the promotion content is improved.

In this embodiment, the linked promotion content in a content position in the first content position subset is displayed in response to the promotion content presentation condition being met, and that the linked promotion content in the first content position subset is gradually moved from the first content position subset to a content position in the second content position subset is displayed. In this way, the linked promotion content can be dynamically moved in the information flow interface, the interaction between the content cover and the linked promotion content is implemented, and the display effect of the promotion content is improved.

In some embodiments, the linked promotion content displayed in the at least two content positions points to a target content position. After the jointly displaying, through at least two of the plurality of content positions in response to a promotion content presentation condition being met, a linked promotion content configured for promoting a target object, the method further includes: displaying a content interface corresponding to the content cover in response to a triggering operation performed on the content cover displayed in the target content position, and displaying the multimedia content or the promotion content in the content interface, the content interface further including a provided promotion link of the target object; and displaying a detail interface about the target object in response to a triggering operation performed on the promotion link.

For example, the linked promotion content includes pointing information.

The pointing information is configured for presenting a content cover associated with the linked promotion content. The content position in which the content cover is located is a target content position to which the linked promotion content points.

A corresponding content interface is jumped to in response to the triggering operation performed on the content cover. The content interface may be configured for presenting the multimedia content, and the multimedia content includes a promotion link about the target object.

In some examples, the content interface may be another promotion content configured for presenting the target object, In some examples, a promotion content. The promotion content is a universal promotion content of a non-linked type. The promotion content includes the promotion link about the target object.

A representation form of the pointing information may be a gesture of a virtual character in the linked promotion content. The gesture points to a content cover or a promotion content in the information flow interface, to remind that a current login account may jump the interface to a detail interface of the target object by triggering the content cover.

The pointing information may also be presented in a form of a text or an audio, and the content cover or the promotion content that can be clicked/tapped by the current login account is indicated through the text or the audio.

For example, the linked promotion content displays a dynamic element in an overlay manner. The dynamic element performs a repetitive reciprocating dynamic effect between the target content position and the content position occupied by the linked promotion content, to indicate that the content cover in the target content position of the current login account is associated with the linked promotion content. In this way, the pointed target content position can be determined through the dynamic effect of the dynamic element.

In this embodiment, based on that the linked promotion content displayed in the at least two content positions points to a target content position, a content interface corresponding to the content cover is displayed in response to a triggering operation performed on the content cover displayed in the target content position, and the multimedia content or the promotion content in the content interface is displayed, the content interface further including a provided promotion link of the target object. In response to a triggering operation performed on the promotion link, an interface switching process of switching the information flow interface to a detail interface displaying the target object is completed more conveniently. In this way, based on the target content position to which the linked promotion content points, a manner for entering a detail interface is additionally provided for the user, so that the user can view details information of the target object in real time, thereby improving user experience.

In some embodiments, the jointly displaying, through at least two of the plurality of content positions in response to a promotion content presentation condition being met, a linked promotion content configured for promoting a target object includes: jointly displaying, through at least two of the plurality of content positions in response to the sliding operation continuously triggered on the information flow interface, the linked promotion content configured for promoting the target object.

For example, after new content positions (configured for displaying a content cover of one loaded multimedia content) are continuously displayed based on the sliding direction of the sliding operation, the terminal determines, in response to the sliding operation that is continuously triggered on the information flow interface and that slides in the sliding direction, that a promotion content display condition is met. The terminal jointly displays, through at least two of the plurality of content positions, the linked promotion content configured for promoting the target object.

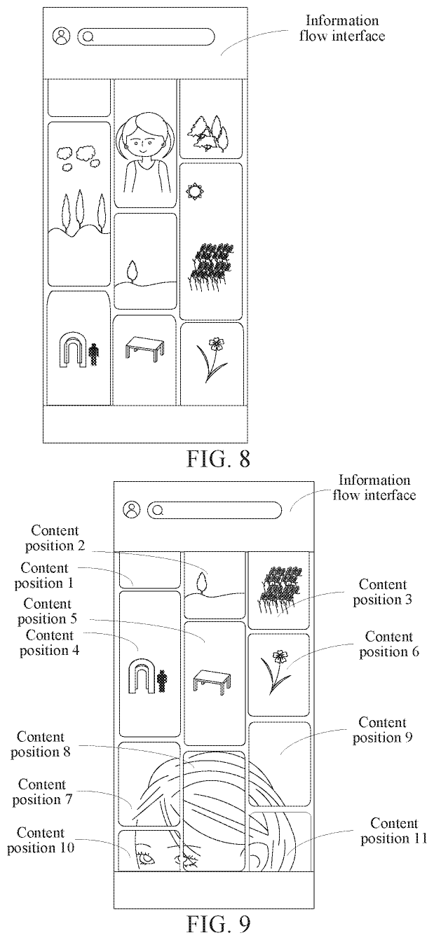

For example, in response to a sliding operation triggered on the information flow interface, new content positions are continuously displayed in the information flow interface based on a sliding direction of the sliding operation. FIG. 8 is a schematic diagram of an information flow interface according to some embodiments. In FIG. 8, a content cover of one multimedia content is displayed at each new content position, In some examples, an information flow including a content cover is presented in the information flow interface in FIG. 8. Then, in response to a sliding operation of continuing to slide in the information flow interface in FIG. 8, some content of the linked promotion content starts to be displayed in the information flow interface. FIG. 9 is a schematic diagram of an information flow interface according to some embodiments. Content positions 7 to 11 in FIG. 9 are some contents of the linked promotion content. Then, in response to the continuously triggered sliding operation performed on the information flow interface in FIG. 9, the linked promotion content is completely displayed, referring to FIG. 4.

In the foregoing process, an arrangement manner of each content position in the information flow interface may be considered as an information flow promotion content square array. The information flow promotion content square array may be an information flow only including a content cover shown in FIG. 8, or may be an information flow including both the content cover and the linked promotion content shown in FIG. 9 or FIG. 4.

For example, if a current login account is not interested in the linked promotion content, the sliding operation continues to be performed, to update a content position in the information flow interface, so that the linked promotion content is not presented in a new content position.

In this embodiment, after the new content position is slid out based on the sliding direction of the sliding operation, the continuous sliding operation is continued to be performed based on the sliding direction, the linked promotion content is displayed, an interaction manner the same as that of the content cover of the multimedia content is maintained, and browsing convenience of the user is improved. In some examples, the operations of triggering to present the content cover and the linked promotion content are both set to sliding operations, and interaction manners of triggering to browse the content cover and the linked promotion content are unified, providing user experience.

In some embodiments, each local promotion content in the linked promotion content is configured for presenting different promotion contents about the target object. The method further includes: jumping to a detail interface about the target object from the information flow interface in response to the triggering operation performed on the local promotion content displayed in any one of the at least two content positions occupied by the linked promotion content.

The detail interface is an interface to which the purchase link points.

In some embodiments, different promotion contents correspond to the same purchase link. Different promotion contents correspond to the same detail interface, and the detail interface includes detail information corresponding to each promotion content.

For example, in response to a triggering operation performed on any local promotion content in the linked promotion content, the terminal jumps the information flow interface to a detail interface about the target object. For example, when a triggering operation is performed on the local promotion content 1, a detail interface 1 is jumped to; and when a triggering operation is performed on the local promotion content 2, a detail interface 1 is jumped to.

For example, each promotion content corresponds to a different purchase link. Different promotion content corresponds to different detail interfaces. Each detail interface includes detail information belonging to corresponding promotion content.

For example, in response to a triggering operation performed on any local promotion content in the linked promotion content, the terminal jumps the information flow interface to a detail interface corresponding to the any local promotion content. For example, when a triggering operation is performed on the local promotion content 1, a detail interface 1 is jumped to; and when a triggering operation is performed on the local promotion content 2, a detail interface 2 is jumped to. Details information included in the detail interface 1 and the detail interface 2 are different.

In this embodiment, each local promotion content in the linked promotion content is configured for presenting different promotion contents about the target object. In some examples, the target object is fully presented through the promotion content in different local promotion content. Quickly jumping to a detail interface about the target object from the information flow interface in response to the triggering operation performed on the local promotion content displayed in any one of the at least two content positions occupied by the linked promotion content greatly facilitates user interaction and improves user experience.

In some embodiments, for each of the at least two content positions occupied by the linked promotion content, an area of the content position is associated with a historical browsing frequency of the target object by a current login account, a higher historical browsing frequency indicating a larger area of a corresponding content position.

If each content position has a corresponding detail interface, the historical browsing frequency corresponding to the content position is a frequency at which a current login account browses a corresponding detail interface within a historical time period. A higher historical browsing frequency indicates more interest (more attention) in promotion content in a corresponding content position.

Still using FIG. 6 as an example for description, a content position 3 to a content position 6 respectively correspond to a detail interface 1 to a detail interface 4, and a detail interface 3 to a detail interface 6 all belong to interfaces in the e-commerce client.

A frequency of browsing the detail interface 3 by the current login account in a historical time period is the highest, and an area of the content position 5 corresponding to the detail interface 3 in the linked promotion content is the largest. A frequency of browsing the detail interface 2 in a historical time period is the lowest, an area of the content position 3 corresponding to the detail interface 2 in the linked promotion content is the smallest.

In this embodiment, the areas of the content positions in the linked promotion content are adaptively adjusted with reference to a historical browsing frequency of a current login account, to highlight a content position in which the current login account is most interested, thereby improving user experience.

In some embodiments, the method further includes: displaying a content cover of the multimedia content in other content positions that are tightly filled around at least two content positions in a case that at least two content positions are arranged in an irregular manner and the at least two content positions fail to completely display an original promotion content image.

The original promotion content image is an image of an entire information flow interface. The irregular manner is configured for arranging at least two adjacent content positions in a staggered manner, so as to visually present that the content positions are uneven.

In a case in which at least two adjacent content positions are arranged in an irregular manner, and the at least two content positions cannot completely display the original promotion content image, linked promotion content does not fully occupy the entire information flow interface. Referring to FIG. 6, the local promotion content of the content position 3 to the content position 6 jointly form the linked promotion content. The linked promotion content does not fully occupy the original promotion content image. In this case, other content positions are tightly filled above and below the linked promotion content, for example, the content position 1 to the content position 2, and the content position 7 to the content position 8 in FIG. 6, which are respectively filled with content covers of 4 different multimedia contents.

In this embodiment, in a case that at least two adjacent content positions are arranged in an irregular manner, and the at least two content positions fail to completely display an original promotion content image, a content cover of the multimedia content is displayed in other content positions that are tightly filled around the at least two content positions. In this way, it is ensured that there is no blank or unused space in the information flow interface, seamless fusion and connection between the content cover and the linked promotion content in the information flow interface is implemented, overall aesthetics of the information flow interface is provided, more abundant, compact, and immersive browsing experience is provided for a user, and the user is prevented from being abrupt or interfered when browsing, thereby improving user experience.

In some embodiments, the jointly displaying, through at least two of the plurality of content positions in response to a promotion content presentation condition being met, a linked promotion content configured for promoting a target object includes: display a static linked promotion picture in the information flow interface in response to the promotion content presentation condition being met, the static linked promotion picture occupying at least two adjacent content positions, and local promotion pictures displayed in each of the at least two content positions jointly forming the static linked promotion picture.

The static, linked promotion picture presents the linked promotion content in a picture form or a graphic and textual form.

For example, in response to a promotion content presentation condition being met, the terminal generates a static linked promotion picture about the target object, and presents the static linked promotion picture. The linked promotion picture is generated based on a picture form determined by a service party and the promotion content of the target object. In some examples, if the terminal determines that the linked promotion content with the click-through rate is in a presentation form of a picture based on the click-through rate of the current login account to the linked promotion content of the same type and different objects, it generates the linked promotion picture based on the promotion content of the target object provided by the service party.

For example, new content positions are continuously displayed in the information flow interface with a sliding direction of the sliding operation in response to the sliding operation triggered on the information flow interface, and a content cover of a newly loaded multimedia content is displayed in each new content position.

If different graphic and textual contents is displayed in each content position in the last row, or a graphic and textual content is displayed in the last content position, in response to the sliding operation continuously triggered on the information flow interface, a static linked promotion picture configured for promoting the target object is displayed in the information flow interface.

For example, in a corresponding information flow interface loaded at a previous moment, a multimedia content loaded at a last content position is the graphic and textual content. Next, the sliding operation is continuously triggered, and the information flow interface shown in FIG. 4 is obtained at a current moment. The content position 3 in the information flow interface at the current moment is a last content position in a waterfall interface at a previous moment. To fuse the linked promotion content and the information flow interface at the previous moment more naturally, an expression form of the linked promotion content is the same as an expression form of the multimedia content in a last content position at the previous moment. Therefore, the linked promotion content in FIG. 3A is a linked promotion picture.

In this embodiment, in response to the promotion content presentation condition being met, the static linked promotion picture is displayed in the information flow interface. In some examples, the information flow interface statically presents the linked promotion content in a form of the picture. The static linked promotion picture occupies at least two adjacent content positions, and local promotion pictures displayed in each of the at least two content positions jointly form the static linked promotion picture, so that a plurality of content positions is combined to jointly present a promotion content belonging to the target object, thereby improving a display effect of the promotion content.

In some embodiments, a local promotion picture displayed in each of the at least two content positions includes different promotion contents about the target object. The method further includes: presenting an explanation video about the target object in the operated content position in response to the triggering operation performed on a local promotion picture displayed in any one of the at least two content positions.

The local promotion picture displayed in each of the at least two content positions includes a corresponding promotion content. Different local promotion pictures respectively present different promotion contents. Referring to FIG. 6, the promotion content 1 to the promotion content 4 respectively present amounts corresponding to different purchase quantities. Each promotion content has a corresponding explanation video, and the explanation video is configured for explaining detailed information of the corresponding promotion content.

For example, a description is further provided by using FIG. 6 as an example. In response to the triggering operation performed on the local promotion picture in which the promotion content 1 is located, an explanation video 1 of the promotion content 1 is played in the content position 3. In response to the triggering operation performed on the local promotion picture in which the promotion content 2 is located, an explanation video 2 of the promotion content 2 is played in the content position 4.

For example, during presenting the explanation video about the target object in the operated content position, in response to the triggering operation performed on the explanation video, the information flow interface is jumped to a detail interface about the target object.

In this embodiment, a local promotion picture displayed in each of the at least two content positions includes different promotion contents about the target object. In some examples, different content positions respectively display different promotion contents, and the target object is presented comprehensively and in detail. In this way, in response to the triggering operation performed on the local promotion picture displayed in any one of the at least two content positions, the explanation video about the target object is presented in the operated content position. In this way, the user can play a corresponding explanation video based on an actual requirement of the user, to learn corresponding details in a targeted manner, thereby improving user experience.

In some embodiments, the jointly displaying, through at least two of the plurality of content positions in response to a promotion content presentation condition being met, a linked promotion content configured for promoting a target object includes: displaying a dynamic linked promotion video in the information flow interface in response to the promotion content presentation condition being met, the dynamic linked promotion video occupying at least two adjacent content positions, and local promotion videos displayed in each of the at least two content positions being combined into the dynamic linked promotion video.

The dynamic linked promotion video is to present the linked promotion content in a form of an audio and video or a video.

For example, new content positions are continuously displayed in the information flow interface with a sliding direction of the sliding operation in response to the sliding operation triggered on the information flow interface, and a content cover of a newly loaded multimedia content is displayed in each new content position.

If different video contents are displayed in each content position in the last row, or a video content is displayed in the last content position, in response to the sliding operation continuously triggered on the information flow interface, a dynamic linked promotion video configured for promoting the target object is displayed in the information flow interface.

In this embodiment, a dynamic linked promotion video in the information flow interface is displayed in response to the promotion content presentation condition being met. In some examples, the linked promotion content is dynamically presented in a video form in the information flow interface. The dynamic linked promotion video occupying at least two adjacent content positions, and local promotion videos displayed in each of the at least two content positions being combined into the dynamic linked promotion video, so that the plurality of content positions is combined to jointly present one promotion content belonging to the target object, thereby improving the display effect of the promotion content.

In the foregoing promotion content display method, the information flow interface is displayed, the information flow interface includes the plurality of content positions, and each of the content positions is configured for displaying the content cover of the multimedia content. In this way, more real-time multimedia content can be provided for the user based on the plurality of content positions in the information flow interface, ensuring pushing efficiency and timeliness of the multimedia content. In response to the promotion content presentation condition being met, the linked promotion content configured for promoting the target object is jointly displayed through at least two of the plurality of content positions. The linked promotion content is configured for promoting the target object. In this way, the linked promotion content is naturally integrated into an interface configured for promoting the multimedia content, a native format is maintained, and user experience is ensured. Each of the at least two content positions displays a local promotion content of the linked promotion content. In some examples, the target object is jointly promoted in the information flow interface in combination with the plurality of content positions, so that features of the target object can be maximally presented, and the display effect of the promotion content is improved.

In some embodiments, after the jointly displaying, through at least two of the plurality of content positions in response to a promotion content presentation condition being met, a linked promotion content configured for promoting a target object, the method further includes: performing a target linked special effect on each of the content positions occupied by the linked promotion content, the target linked special effect being an animation special effect enabling interaction of the local promotion content displayed in each of the content positions; and displaying that the local promotion content in each of the content positions interacts with each other through the target linked special effect.

The target linked special effect is an animation special effect that enables the local promotion content in at least two adjacent content positions occupied by the linked promotion content to dynamically interact with each other. For the local promotion content in at least two adjacent content positions occupied by the linked promotion content, the target linked special effect is a special effect that enables the at least two local promotion contents to dynamically interact with each other.

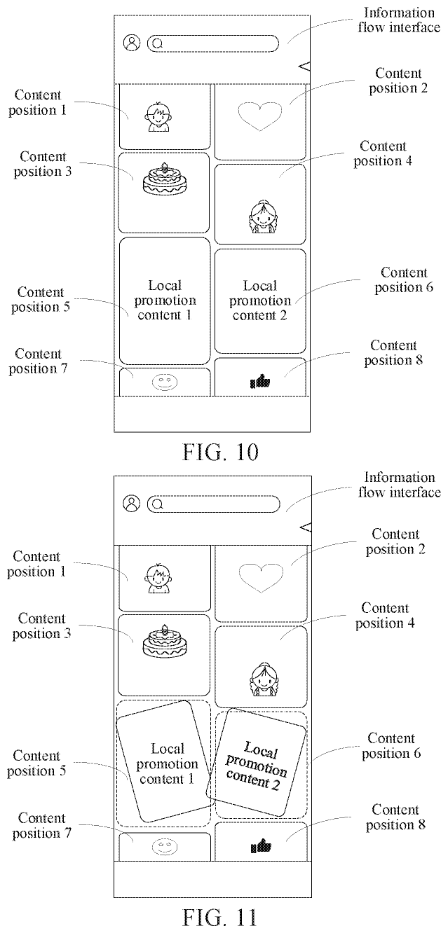

FIG. 10 is a schematic diagram of an information flow interface according to some embodiments. The linked promotion content occupies the content position 5 and the content position 6, and are respectively configured for displaying the local promotion content 1 and the local promotion content 2. If the target linked special effect is causing collision interaction between the local promotion content 1 and the local promotion content 2, FIG. 11 is a schematic diagram of a target linked special effect according to some embodiments. The local promotion content 1 and the local promotion content 2 in FIG. 11 perform collision interaction with reference to a manner of clinking glasses.

In some embodiments, the target linked special effect is associated with a scenario used by the target object. For example, if the target object is the beverage, and the use scenario is a celebrating scenario, the target linked special effect is a dynamic effect of collision.

In some embodiments, if the linked promotion content is the linked promotion video, the target linked special effect is related to a played video clip.

For example, the performing a target linked special effect on each of the content positions occupied by the linked promotion content, and displaying that the local promotion content in each of the content positions interacts with each other through the target linked special effect includes: performing, for at least two content positions occupied by a local promotion video presenting the vibration event when the linked promotion video is played to a video clip including a vibration event, a target linked special effect associated with the vibration event, and displaying that the local promotion contents in the at least two content positions interact with each other through the target linked special effect.

For example, the vibration event may be letting off fireworks, vibration of a mobile phone, and shaking of a desktop. Content positions occupied by the linked promotion video include the content position 5 to the content position 11. When the video clip including the vibration event is played, the content positions occupied by the vibration event are the content position 5 and the content position 6, and a dynamic effect of the vibration is performed on the local promotion content in the content position 5 and the content position 6.

In this embodiment, a target linked special effect is performed on each of the content positions occupied by the linked promotion content, the target linked special effect being an animation special effect enabling interaction of the local promotion content displayed in each of the content positions. In this way, that the local promotion contents in content positions interact with each other through the target linked special effect is displayed. In some examples, the plurality of content positions occupied by the linked promotion content are combined with the same special effect, a promotion content creative is enhanced, and a click-through rate of the promotion content is effectively increased.

In some embodiments, after the jointly displaying, through at least two of the plurality of content positions in response to a promotion content presentation condition being met, a linked promotion content configured for promoting a target object, the method further includes: displaying a target linked element on the linked promotion content in an overlay manner, the target linked element matching the target object, the target linked element being distributed in at least two content positions occupied by the linked promotion content, and local elements displayed on the local promotion content in each of the content positions in an overlay manner jointly forming the target linked element.

For the at least two content positions occupied by the linked promotion content, the target linked element refers to an element superposed on the local promotion content of the at least two content positions occupied by the linked promotion content. The element spans a plurality of content positions and corresponds to each of the at least two content positions. A local element displayed in the content position in an overlay manner belongs to a part of the target linked element, and matches the target object.

The target linked element matches the target object. For example, the target linked element is associated with a scenario used by the target object. For example, if the target object is the beverage and the scenario used by the beverage is a celebrating scenario, to better integrate the scenario, the target linked element may be an element such as a firework or a dragon.

For another example, the target linked element may be a virtual character in the linked promotion content.

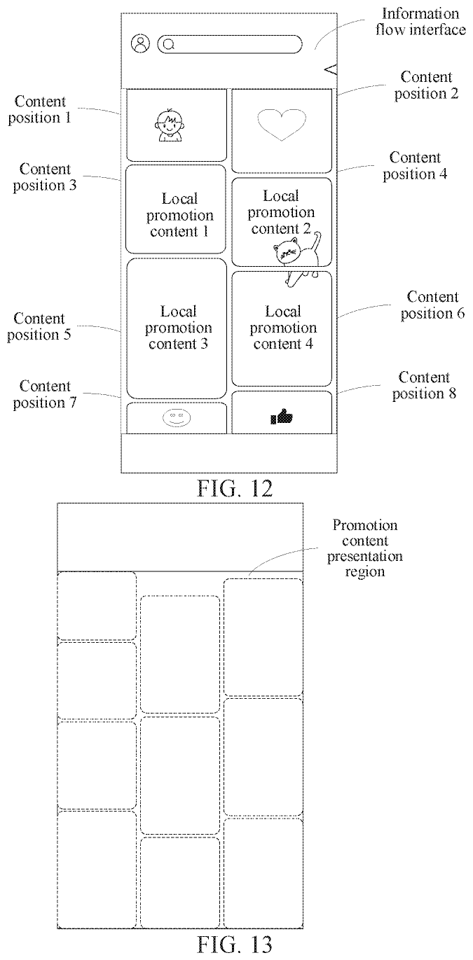

For example, the target linked element may be a static linked element or a dynamic linked element. For example, the target linked element moves in the linked promotion content with a preset moving trajectory. FIG. 12 is a schematic diagram of a target linked element according to some embodiments. The target linked element in FIG. 12 is a cat. During presenting the linked promotion content, the cat moves in the linked promotion content in a preset moving trajectory.

For example, the target linked element relates to a plurality of content positions occupied by the linked promotion content. If local elements of the plurality of content positions are continuous, the local elements of the plurality of content positions are spliced to obtain the target linked element. In some examples, local elements of the plurality of content positions are not continuous, namely, are completely different, but are all associated with the target article.

For example, the target linked element may be displayed in a progressive manner and moved out in a progressive manner. For example, in response to the promotion content presentation condition being met, after the linked promotion content is completely displayed, the target linked element is displayed in a progressive manner, and in response to the linked promotion content being completely displayed for a preset duration, the target linked element is removed from the linked promotion content in a progressive manner.

In some other examples, when the linked promotion content is a linked promotion video, the method further includes: displaying, in a plurality of content positions occupied by the key video clip, a target linked element associated with the key video clip in an overlay manner when the linked promotion video is played to the key video clip. The key video clip is a video clip in which the target object appears.

When the key video clip is not played, or the key video clip is completely played, the target linked element is not displayed in the linked promotion video in an overlay manner.

In this embodiment, a target linked element is displayed on the linked promotion content in an overlay manner, the target linked element matching the target object, the target linked element being distributed in at least two content positions occupied by the linked promotion content, and local elements displayed on the local promotion content in each of the content positions in an overlay manner jointly forming the target linked element. In this way, that the target linked element intersects at least two content positions occupied by the linked promotion content is implemented, interestingness of the promotion content is improved, and a click-through rate of the promotion content is effectively increased.

In some embodiments, the operation of determining the linked promotion content includes: obtaining a promotion content of the target object and content position information configured for presenting the promotion content, the content position information including a region area of a promotion content presentation region of the target object and a quantity of content positions of content positions configured for presenting the promotion content; constructing a mask layer based on the presentation region and the quantity of content positions, the mask layer including a plurality of content positions arranged in an irregular manner; and superposing the mask layer onto the promotion content, to obtain the linked promotion content.

The promotion content is information for displaying in the linked promotion content. The content position information is configured for generating the linked promotion content. The mask layer refers to a layer that is constructed based on the region area of the promotion content presentation region of the target object and the quantity of content positions configured for presenting the content position of the promotion content and that includes a plurality of content positions arranged in an irregular manner, and is configured for being superposed onto the promotion content to obtain the linked promotion content.

For example, the terminal receives a generation request transmitted by a service party. The generation request includes a promotion content of the target object and content position information configured for presenting the promotion content. The content position information includes the region area of the promotion content presentation region of the target object and the quantity of content positions of content positions configured for presenting the promotion content.

The terminal constructs the mask layer based on the region area of the promotion content presentation region and the quantity of content positions, and superposes the mask layer onto the promotion content, to obtain the linked promotion content.

For example, the terminal constructs the mask layer based on the region area, the quantity of content positions, and the quantity of rows occupied by the linked promotion content.

When the mask layer is constructed, a sub-component StaggeredGridLayoutManager in an efficient sliding component RecyclerView configured for presenting a large quantity of data sets is used. A size and a distribution range of content positions are determined based on the region area by setting different parameters such as a row height, a column width, and a content position spacing, and a specific quantity and an arrangement manner of the content positions are determined based on the quantity of the content positions, so as to construct the mask layer. The mask layer includes a plurality of content positions arranged in an irregular manner. The mask layer is superposed onto the promotion content, to obtain the linked promotion content.

For example, the terminal obtains a to-be-presented information flow. The information flow includes a content covers of a plurality of multimedia contents for presentation, determines an insertion position of the linked promotion content in the information flow, determines a first content position that is before the linked promotion content and that is adjacent to the linked promotion content, and obtains a second content position that is after the linked promotion content and that is adjacent to the linked promotion content. The first content position and the second content position are both configured for presenting the content cover of the corresponding multimedia content.

Content positions in the to-be-presented information flow that are configured for presenting content covers are arranged in an irregular arrangement manner, to form an arrangement layout of a waterfall flow. For example, the to-be-pushed content cover is arranged by using the sub-component StaggeredGridLayoutManager in the efficient sliding component RecyclerView configured for presenting a large quantity of data sets, to obtain an information flow.

The terminal generates a promotion content presentation region based on the region area of the promotion content presentation region, and inserts the promotion content presentation region into the information flow between the first content position and the second content position based on the position information of the first content position and the second content position. The terminal generates the mask layer based on the position information of each content position in the promotion content presentation region and the quantity of the content positions, superposes the mask layer to the promotion content, to obtain the linked promotion content, and superposes the linked promotion content to the promotion content presentation region, to obtain the target information flow finally for presentation in the information flow interface.

A process of generating the linked promotion content is described below by using an example. First, the terminal determines position information and the region area of the promotion content presentation region in the to-be-presented information flow based on the content position information. The terminal determines a plurality of first content positions and a plurality of second content positions based on the position information. The terminal determines a region width of the promotion content presentation region based on the position information, adjusts a spacing between the first content position and the second content position based on the region width, and aligns a bottom of each first content position and aligns a top of each second content position, so that the spacing is the region width of the promotion content presentation region, to obtain the promotion content presentation region. FIG. 13 is a schematic diagram of a promotion content presentation region according to some embodiments. Based on the promotion content presentation region and the quantity of content positions shown in FIG. 13, position information of each content position in the promotion content presentation region is determined.

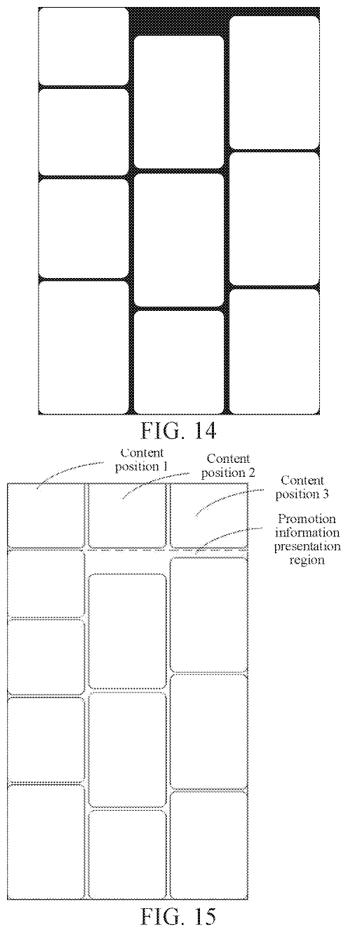

Next, the terminal constructs a mask layer based on the position information of each content position in the promotion content presentation region. FIG. 14 is a schematic diagram of a mask layer according to some embodiments. A gray region in FIG. 14 is an opaque region, a white region is a content position, and the white region is a transparent region. For example, by using an OnDraw method for drawing a user-defined view on a screen, the mask layer is drawn through a Path class (which allows a complex picture and path to be customized, and the path is drawn onto a Canvas) and a Canvas class (which provides a drawing region).

Finally, the terminal superposes the mask layer to the promotion content, to obtain the linked promotion content, and superposes the linked promotion content to the promotion content presentation region, to obtain the target information flow finally for presentation. FIG. 15 is a schematic diagram of a target information flow according to some embodiments.

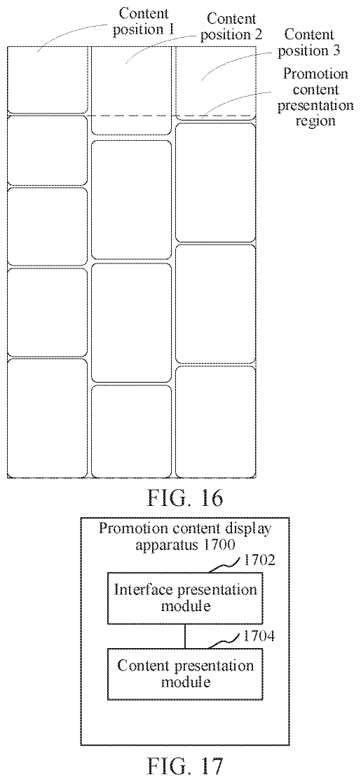

In some examples, because the content position 2 and the content position 3 configured for presenting the content cover in FIG. 15 are blocked by the promotion content presentation region, the content cover fails to be completely presented. Based on this, the layer relationship between the first content position and the linked promotion content is set. In some examples, the first content position is set on the linked promotion content in a direction perpendicular to the information flow interface. In this way, it can be ensured that the content cover is completely displayed. Similarly, to prevent the second content position from being blocked by the promotion content presentation region, the second content position is set on the linked promotion content. FIG. 16 is a schematic diagram of a target information flow according to some embodiments. Content covers of the content position 2 and the content position 3 in FIG. 16 are completely displayed.

For example, the terminal sets clipChildren=false (the subview is allowed to extend beyond a boundary thereof when drawn), to allow the content position at which the content cover is located to cross the promotion content presentation region, sets that a z value of the first content position is greater than a z value of the linked promotion content, and sets that a z value of the second content position is greater than the z value of the linked promotion content by using ViewCompat.setTranslationZ(.) (a static value set in a direction of the z axis, namely, a value in a direction perpendicular to the information flow interface) or elevation (for defining a position on the axis). In this way, it can be ensured that the first content position and the second content position can be completely displayed, and the content cover of the multimedia content can be not covered when a waterfall flow layout caused by misplacement is implemented, thereby ensuring that the user can browse a complete cover content of the multimedia content.

In this embodiment, the promotion content presentation requirement is determined. In some examples, the promotion content of the target object, the region area of the promotion content presentation region, and the quantity of content positions for presenting the content position of the promotion content are determined. In this way, the linked promotion content can be flexibly designed subsequently based on an actual promotion content presentation requirement, thereby improving flexibility of presentation of the promotion content. Then, a matching mask layer is constructed based on the presentation region and the quantity of the content positions. The mask layer includes a plurality of content positions arranged in an irregular manner. The mask layer is superposed onto the promotion content, to obtain the linked promotion content. In this way, the target object can be maximally presented based on the plurality of content positions occupied in the linked promotion content, thereby improving the promotion efficiency and the display effect of the promotion content.

In some embodiments, the region area of the promotion content presentation region is determined based on the historical browsing frequency of the current login account in the information flow interface, the historical browsing frequency being a historical browsing frequency of another object by the current login account, a type of the another object being the same as a type of the target object, and a higher historical browsing frequency indicating a larger corresponding region area.

The historical browsing frequency in the information flow interface is a historical browsing frequency of the linked promotion content of another object of the same type when the current login account browses the information flow interface.

For example, before the information flow interface presents the linked promotion content of the target object, the information flow interface further presents another linked promotion content within the preset duration. The another linked promotion content may be a plurality of linked promotion content of one other object, or may be one linked promotion content corresponding to each of other linked promotion contents.

A quantity of other linked promotion contents browsed in the preset duration is counted, and a ratio of the quantity to a total quantity of the other linked promotion contents is calculated, to obtain the historical browsing frequency.

If the historical browsing frequency is higher than the first preset frequency, the region area of the promotion content presentation region within preset duration is obtained, the region area is increased based on a preset proportion, and the linked promotion content about the target object is presented based on the increased region area.

If the historical browsing frequency is less than a second preset frequency, the region area is reduced based on the preset proportion, and the linked promotion content about the target object is presented based on the reduced region area. If the historical browsing frequency is between the first preset frequency and the second preset frequency, the region area is not changed.

In this embodiment, the region area of the promotion content presentation region is determined based on the historical browsing frequency of the current login account in the information flow interface, the historical browsing frequency being a historical browsing frequency of another object by the current login account, and a type of the another object being the same as a type of the target object. In this way, a higher historical browsing frequency indicates a higher probability that the current login account browses the promotion content of the target object. In this case, a corresponding region area is enlarged to comprehensively and effectively promote the target object, thereby improving promotion content promotion efficiency while ensuring user experience.

Present disclosure further provides an application scenario. The foregoing promotion content display method is applied to the application scenario. Application of the promotion content display method to the application scenario is, for example, as follows: In a multimedia content pushing scenario, a target object in the scenario may be a target commodity, a target video, or the like. After a current login account logs in to a user-generated content client, the terminal displays an information flow interface in the user-generated content client. The information flow interface includes a plurality of content positions, and each of the content positions is configured for displaying a content cover of one multimedia content. A linked promotion content configured for promoting a target object is jointly displayed through at least two of the plurality of content positions in response to a promotion content presentation condition is met, the linked promotion content is configured for promoting the target object, and each of the at least two content positions displays a local promotion content of the linked promotion content. In this way, the target object is jointly promoted in the information flow interface in combination with a plurality of content positions, so that features of the target object can be maximally presented, and a display effect of the promotion content is improved.

Certainly, this is not limited thereto. The promotion content display method provided in present disclosure may further be applied to another application scenario. For example, in a video pushing scenario, the current login account logs in to a video client. In this scenario, the multimedia content may be a video content that has been followed, and the target object is other video content that has not been followed. For example, an information flow interface in a video client is displayed. The information flow interface includes a plurality of content positions, and each of the content positions is configured for displaying the content cover of one followed video content. A linked promotion content configured for promoting a target object is jointly displayed through at least two of the plurality of content positions in response to a promotion content presentation condition being met, the linked promotion content is configured for promoting other video contents that have not been followed, and each of the at least two content positions displays a local promotion content of the linked promotion content.

The foregoing application scenarios are merely exemplary descriptions. The promotion content display method provided in embodiments of present disclosure is not limited to being applied to the foregoing scenarios.

In a specific embodiment, a promotion content display method is provided, and a specific process of the method is as follows:
Operation 1: A terminal logs in to a target client by using a current login account, and the target client may be a user-generated content client. The terminal displays an information flow interface of the target client, where the information flow interface includes a plurality of content positions, and each of the content positions is configured for displaying a content cover of one multimedia content.
Operation 2: A terminal continuously displays new content positions in the information flow interface with a sliding direction of the sliding operation in response to the sliding operation triggered on the information flow interface, and displays a content cover of one loaded multimedia content in each new content position, the multimedia content being issued through a multimedia account. The terminal jointly displays, through at least two of the plurality of content positions in response to the sliding operation continuously triggered on the information flow interface, the linked promotion content configured for promoting the target object.

A multimedia account refers to an account issuing a multimedia content. The account may be an account followed by a current login account, or may be an account not followed by a current login account.

A content cover of the multimedia content is displayed in other content positions that are tightly filled around at least two content positions in a case that at least two adjacent content positions are arranged in an irregular manner and the at least two content positions fail to completely display an original promotion content image.

In some examples, in a case that the linked promotion content is a static linked promotion content, the terminal displays a static linked promotion picture in the information flow interface in response to the promotion content presentation condition being met, the static linked promotion picture occupies at least two adjacent content positions, and local promotion pictures displayed in each of the at least two content positions jointly form the static linked promotion picture.

The local promotion picture displayed in each of the at least two content positions includes different promotion contents about the target object. After the linked promotion picture is presented, an explanation video about the target object is presented in the operated content position in response to the triggering operation performed on a local promotion picture displayed in any one of the at least two content positions.

In some examples, in a case that the linked promotion content is a dynamic linked promotion video, the terminal displays a dynamic linked promotion video in the information flow interface in response to the promotion content presentation condition being met, the dynamic linked promotion video occupies at least two adjacent content positions, and local promotion videos displayed in each of the at least two content positions are combined into the dynamic linked promotion video.

In some examples, the linked promotion content configured for promoting the target object is jointly displayed through at least two of the plurality of content positions in response to triggering a sliding operation performed on the information flow interface. In some examples, the linked promotion content that is configured for promoting the target object and matches a sliding speed of the sliding operation is jointly displayed through at least two of the plurality of content positions in response to triggering the sliding operation performed on the information flow interface, and different sliding speed ranges match linked promotion contents configured for promoting different types of target objects. In some examples, the linked promotion content that is configured for promoting the target object and matches typesetting information of the content positions in the current display region is jointly displayed by sliding to at least two of the content positions in a current display region in response to triggering the sliding operation performed on the information flow interface, and different typesetting information are correspondingly configured for promoting linked promotion contents of different types of objects.

In some examples, if the display sequence of the local promotion contents respectively displayed in the at least two content positions is the same as an exposure sequence of the at least two content positions, the exposure sequence of the at least two content positions occupied by the linked promotion content is obtained. A corresponding local promotion content in each of the at least two content positions in the information flow interface is sequentially displayed based on the exposure sequence of the at least two content positions in response to a promotion content presentation condition being met.

In some examples, if the at least two content positions includes a center content position located in a middle position and an outer content position surrounding the center content position, that the linked promotion content in the center content position is gradually enlarged is displayed until the outer content position of the at least two content positions is occupied after the linked promotion content is displayed in the center content position of the at least two content positions in response to the promotion content presentation condition being met.

In some examples, if the at least two content positions include the first content position subset and the second content position subset, the linked promotion content in a content position in the first content position subset is displayed in response to the promotion content presentation condition being met, and that the linked promotion content in the first content position subset is gradually moved from the first content position subset to a content position in the second content position subset is displayed.

The foregoing operation of determining the linked promotion content includes: obtaining a promotion content of the target object and content position information configured for presenting the promotion content, the content position information including a region area of a promotion content presentation region of the target object and a quantity of content positions of content positions configured for presenting the promotion content; constructing a mask layer based on the presentation region and the quantity of content positions, the mask layer including a plurality of content positions arranged in an irregular manner; and superposing the mask layer onto the promotion content, to obtain the linked promotion content.

The region area of the promotion content presentation region is determined based on the historical browsing frequency of the current login account in the information flow interface, the historical browsing frequency being a historical browsing frequency of another object by the current login account, a type of the another object being the same as a type of the target object, and a higher historical browsing frequency indicating a larger corresponding region area.
Operation 3: After jointly display, through at least two of the plurality of content positions in response to a promotion content presentation condition being met, a linked promotion content configured for promoting a target object, the terminal performs a target linked special effect on each of the content positions occupied by the linked promotion content, the target linked special effect being an animation special effect enabling interaction of the local promotion content displayed in each of the content positions; and displays that the local promotion content in each of the content positions interacts with each other through the target linked special effect.

In some examples, a target linked element is displayed on the linked promotion content in an overlay manner, the target linked element matching the target object, the target linked element being distributed in at least two content positions occupied by the linked promotion content, and local elements displayed on the local promotion content in each of the content positions in an overlay manner jointly forming the target linked element.
Operation 4: Each local promotion content in the linked promotion content being configured for presenting different promotion content about the target object. The method further includes: jumping to a detail interface about the target object from the information flow interface in response to the triggering operation performed on the local promotion content displayed in any one of the at least two content positions occupied by the linked promotion content.

For each of the at least two content positions occupied by the linked promotion content, an area of the content position is associated with a historical browsing frequency of the target object by a current login account, a higher historical browsing frequency indicating a larger area of a corresponding content position.

In some examples, if the linked promotion content displayed in the at least two content positions points to a target content position, after the linked promotion content configured for promoting the target object is jointly displayed through at least two of the plurality of content positions, the content interface corresponding to the content cover is displayed in response to a triggering operation performed on the content cover displayed in the target content position, and the multimedia content or the promotion content is displayed in the content interface, the content interface further including a provided promotion link of the target object; and a detail interface about the target object is displayed in response to a triggering operation performed on the promotion link.

In this embodiment, an information flow interface is displayed, where the information flow interface includes a plurality of content positions, and each of the content positions is configured for displaying a content cover of one multimedia content. In this way, more real-time multimedia content can be provided for the user based on the plurality of content positions in the information flow interface, ensuring pushing efficiency and timeliness of the multimedia content. In response to the promotion content presentation condition being met, the linked promotion content configured for promoting the target object is jointly displayed through at least two of the plurality of content positions. The linked promotion content is configured for promoting the target object. In this way, the linked promotion content is naturally integrated into an interface configured for promoting the multimedia content, a native format is maintained, and user experience is ensured. Each of the at least two content positions displays a local promotion content of the linked promotion content. In some examples, the target object is jointly promoted in the information flow interface in combination with the plurality of content positions, so that features of the target object can be maximally presented, and the display effect of the promotion content is improved.

Although the operations in the flowcharts involved in some embodiments described above are displayed in sequence as indicated by arrows, these operations are not necessarily performed in sequence as indicated by the arrows. Unless otherwise explicitly specified in present disclosure, execution of the operations is not strictly limited, and the operations may be performed in another sequence. In some examples, at least some of the operations in each embodiment may include a plurality of operations or a plurality of stages. The operations or stages are not necessarily performed at the same moment but may be performed at different moments. The operations or stages are not necessarily performed in sequence, but may be performed in turn or alternately with other operations or at least some of operations or stages in other operations.

Some embodiments of present disclosure further provides a promotion content display apparatus configured to implement the foregoing promotion content display method. An implementation solution provided by the apparatus for resolving the problem is similar to the implementation solution described in the foregoing method. Therefore, for specific limitations on one or more embodiments of the promotion content display apparatus provided below, reference may be made to the limitations on the promotion content display method above. Details are not described herein again.

In some embodiments, as shown in FIG. 17, a promotion content display apparatus 1700 is provided, including: an interface presentation module 1702 and a content presentation module 1704.

Unless explicitly described or implicitly understood from the embodiments of the present disclosure, at least one of the components, elements, modules, units, or nominalized verbs represented by a block or equivalent indication in the drawings may be implemented or embodied by software (e.g., a program) including one or more instructions stored in an internal or external storage medium that is readable by one or more processors. For example, the one or more processors may invoke at least one of the one or more instructions stored in the storage medium and execute it, with or without using one or more other components under the control of the one or more processors. This allows the one or more processors to perform at least one function or operation described above as being performed by each of the components according to the one or more instructions invoked. The one or more processors may include a central processing unit (CPU) to perform at least a portion of the one or more instructions and hardware accelerators such as a graphics processing unit (GPU), neural processing unit (NPU), tensor processing unit (TPU), vision processing unit (VPU), digital signal processor (DSP), special-purpose system on chip (SoC) (e.g., edge SoC), application-specific integrated circuit (ASIC), field-programmable gate array (FPGA), in-memory computing (IMC), quantum accelerator, or microcontroller. One or more nodes of a distributed computing system may perform the one or more instructions.

The interface presentation module 1702 is configured to display an information flow interface. The information flow interface includes a plurality of content positions, and each of the content positions is configured for displaying a content cover of one multimedia content.

The content presentation module 1704 is configured to jointly display, through at least two of the plurality of content positions in response to a promotion content presentation condition being met, a linked promotion content configured for promoting a target object. The linked promotion content is configured for promoting the target object. The linked promotion content occupies the at least two adjacent content positions. The local promotion contents displayed in each of the at least two content positions jointly form the linked promotion content.

In some embodiments, the content presentation module is configured to jointly display, through at least two of the plurality of content positions in response to triggering a sliding operation performed on the information flow interface, the linked promotion content configured for promoting the target object. In some examples, the linked promotion content that is configured for promoting the target object and matches a sliding speed of the sliding operation is jointly displayed through at least two of the plurality of content positions in response to triggering the sliding operation performed on the information flow interface, and different sliding speed ranges match linked promotion contents configured for promoting different types of target objects. In some examples, the linked promotion content that is configured for promoting the target object and matches typesetting information of the content positions in the current display region is jointly displayed by sliding to at least two of the content positions in a current display region in response to triggering the sliding operation performed on the information flow interface, and different typesetting information are correspondingly configured for promoting linked promotion contents of different types of objects.

In some embodiments, the apparatus further includes a content cover presentation module, the content cover presentation module being configured to continuously display new content positions in the information flow interface with a sliding direction of the sliding operation in response to the sliding operation triggered on the information flow interface, and display a content cover of one loaded multimedia content in each new content position, the multimedia content being issued through a multimedia account; and a content presentation module, configured to jointly display, through at least two of the plurality of content positions in response to the sliding operation continuously triggered on the information flow interface, the linked promotion content configured for promoting the target object.

In some embodiments, a display sequence of the local promotion contents respectively displayed in the at least two content positions is the same as an exposure sequence of the at least two content positions. The content presentation module is configured to obtain an exposure sequence of at least two content positions occupied by linked promotion content; and sequentially display, in response to a promotion content presentation condition being met, a corresponding local promotion content in each of the at least two content positions in the information flow interface based on the exposure sequence of the at least two content positions.

In some embodiments, the at least two content positions include a center content position located in a middle position and an outer content position surrounding the center content position. The content presentation module 1704 is configured to display that the linked promotion content in the center content position is gradually enlarged until the outer content position of the at least two content positions is occupied after the linked promotion content is displayed in the center content position of the at least two content positions in response to the promotion content presentation condition being met.

In some embodiments, the at least two content positions include a first content position subset and a second content position subset. The content presentation module 1704 is configured to display the linked promotion content in a content position in the first content position subset in response to the promotion content presentation condition being met, and display that the linked promotion content in the first content position subset is gradually moved from the first content position subset to a content position in the second content position subset.

In some embodiments, the linked promotion content displayed in the at least two content positions points to a target content position. The interface presentation module 1702 is further configured to display a content interface corresponding to the content cover in response to a triggering operation performed on the content cover displayed in the target content position, and display the multimedia content or the promotion content in the content interface, the content interface further including a provided promotion link of the target object; and display a detail interface about the target object in response to a triggering operation performed on the promotion link.

In some embodiments, the content presentation module 1704 is configured to display a static linked promotion picture in the information flow interface in response to the promotion content presentation condition being met, the static linked promotion picture occupies at least two adjacent content positions, and local promotion pictures displayed in each of the at least two content positions jointly form the static linked promotion picture.

In some embodiments, a local promotion picture displayed in each of the at least two content positions includes different promotion contents about the target object. The apparatus further includes a video presentation module, where the video presentation module is configured to present an explanation video about the target object in the operated content position in response to the triggering operation performed on a local promotion picture displayed in any one of the at least two content positions.

In some embodiments, the content presentation module 1704 is configured to display a dynamic linked promotion video in the information flow interface in response to the promotion content presentation condition being met, the dynamic linked promotion video occupies at least two adjacent content positions, and local promotion videos displayed in each of the at least two content positions are combined into the dynamic linked promotion video.

In some embodiments, the content presentation module 1704 is further configured to perform a target linked special effect on each of the content positions occupied by the linked promotion content, the target linked special effect being an animation special effect enabling interaction of the local promotion content displayed in each of the content positions; and display that the local promotion content in each of the content positions interacts with each other through the target linked special effect.

In some embodiments, the content presentation module 1704 is further configured to display a target linked element on the linked promotion content in an overlay manner, the target linked element matching the target object, the target linked element being distributed in at least two content positions occupied by the linked promotion content, and local elements displayed on the local promotion content in each of the content positions in an overlay manner jointly forming the target linked element.

In some embodiments, each local promotion content in the linked promotion content is configured for presenting different promotion contents about the target object. The apparatus further includes a jumping module, where the jumping module is configured to jump to a detail interface about the target object from the information flow interface in response to the triggering operation performed on the local promotion content displayed in any one of the at least two content positions occupied by the linked promotion content.

In some embodiments, for each of the at least two content positions occupied by the linked promotion content, an area of the content position is associated with a historical browsing frequency of the target object by a current login account, a higher historical browsing frequency indicating a larger area of a corresponding content position.

In some embodiments, the content cover presentation module is further configured to play a content cover of the multimedia content in other content positions that are tightly filled around at least two content positions in a case that at least two adjacent content positions are arranged in an irregular manner and the at least two content positions fail to completely display an original promotion content image.

In some embodiments, the apparatus further includes an image determining module, where the image determining module is configured to obtain a promotion content of the target object and content position information configured for presenting the promotion content, the content position information including a region area of a promotion content presentation region of the target object and a quantity of content positions of content positions configured for presenting the promotion content; and construct a mask layer based on the presentation region and the quantity of content positions, the mask layer including a plurality of content positions arranged in an irregular manner; and superpose the mask layer onto the promotion content, to obtain the linked promotion content.

In some embodiments, the region area of the promotion content presentation region is determined based on the historical browsing frequency of the current login account in the information flow interface, the historical browsing frequency being a historical browsing frequency of another object by the current login account, a type of the another object being the same as a type of the target object, and a higher historical browsing frequency indicating a larger corresponding region area.

One or more components of FIG. 17 may be integrated into a single component, or conversely, a single component may be implemented as multiple discrete elements. Additionally or alternatively, different subsets of the illustrated components may be combined in various configurations.

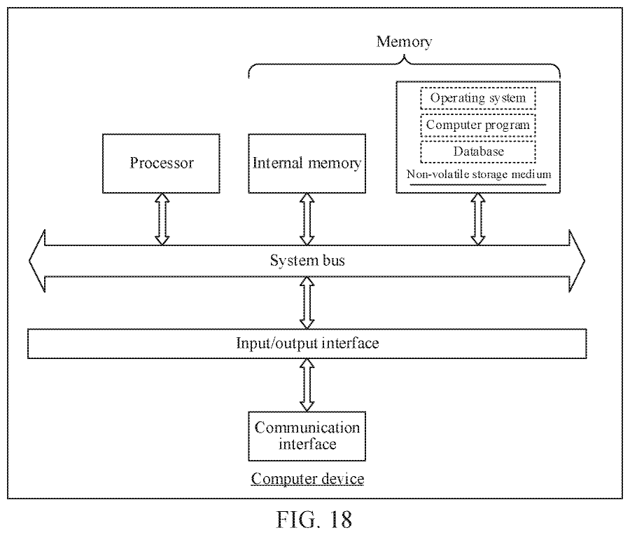

In some embodiments, a computer device is provided. The computer device may be a server or a terminal, and an internal structural diagram thereof may be shown in FIG. 18. The computer device includes a processor, a memory, an input/output (I/O for short) interface, and a communication interface. The processor, the memory, and the I/O interface are connected through a system bus, and the communication interface is connected to the system bus through the I/O interface. The processor of the computer device is configured to provide computing and control capabilities. The memory of the computer device includes a non-volatile storage medium and an internal memory. The non-volatile storage medium has an operating system, a computer program, and a database stored therein. The internal memory provides an environment for running of the operating system and the computer program in the non-volatile storage medium. The I/O interface of the computer device is configured to exchange information between the processor and an external device. The communication interface of the computer device is configured to connect to and communicate with an external terminal through a network. The computer program, when executed by the processor, implements a promotion content display method.

A person skilled in the art may understand that the structure shown in FIG. 18 is merely a block diagram of a partial structure related to the solution of present disclosure, and does not constitute a limitation on the computer device to which the solution of present disclosure is applied. For example, the computer device may include more or fewer components than those shown in the figure, or some merged components, or different component arrangements.

In some embodiments, a computer device is further provided, including a memory and a processor. The memory stores a computer program. The processor implements the operations in the foregoing method embodiments when executing the computer program.

In some embodiments, a computer-readable storage medium is provided, having a computer program stored therein, the computer program, when executed by a processor, implementing the operations in any one of the foregoing method embodiments.

In some embodiments, a computer program product is provided, including a computer program, the computer program, when executed by a processor, implementing the operations in the foregoing method embodiments.

User information (including but not limited to user device information, user personal information, and the like) and data (including but not limited to data for analysis, stored data, displayed data, and the like) involved in present disclosure are all information and data authorized by users or fully authorized by all parties. Collection, use, and processing of relevant data need to comply with relevant regulations.

A person of ordinary skill in the art may understand that all or some of processes of the method in the foregoing embodiments may be implemented by a computer program instructing relevant hardware. The computer program may be stored in a non-volatile computer-readable storage medium. When the computer program is executed, the processes of the foregoing method embodiments may be implemented. Any reference to a memory, a database, or another medium used in some embodiments provided in present disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. As an illustration rather than a limitation, the RAM is available in various forms, such as a static random access memory (SRAM) or a dynamic random access memory (DRAM). The database involved in some embodiments provided in present disclosure may include at least one of a relational database or a non-relational database. The non-relational database may include a blockchain-based distributed database, or the like, but is not limited thereto. The processor involved in some embodiments provided in present disclosure may be a general-purpose processor, a central processing unit, a graphics processing unit, a digital signal processor, a programmable logic device, a quantum computing-based data processing logic device, an artificial intelligence (AI) processor, or the like, but is not limited thereto.

Based on the above, present disclosure provides a promotion content display method and apparatus, a computer device, a computer-readable storage medium, and a computer program product. By displaying the information flow interface including the plurality of content positions, each of the content positions is configured for presenting a content cover of a multimedia content, and the multimedia content is efficiently pushed. When the promotion content presentation condition is met, the linked promotion content is jointly presented through at least two content positions, and the local promotion content is presented in each content position. This manner optimizes utilization of a display space from a technical layer. Compared with a single content position presentation, the display area of the promotion content is increased, more information about the target object can be carried, information transmission efficiency and accuracy are improved, and features of the target object is maximally presented. For example, a multimedia content promotion interface is naturally integrated, a native format is maintained, interference to user experience is reduced, and user acceptance is improved.

In some embodiments, the linked promotion contents in the at least two content positions are jointly displayed when the promotion content presentation condition is met in response to the sliding operation performed on the information flow interface being detected. This operation uses a common operation habit of the user on the information flow interface, and the promotion content can be quickly presented without an additional user operation instruction by using a real-time monitoring and response mechanism of the system for the sliding operation, thereby simplifying a presentation process of the promotion content, improving timeliness and convenience of presentation, reducing waiting time of the user, and improving user experience.

In some embodiments, if in response to the sliding operation performed on the information flow interface, the linked promotion content matching a sliding speed is jointly displayed in at least two content positions, and different sliding speeds correspond to linked promotion content of different types of target objects. In this solution, presentation of the promotion content is adjusted in real time based on the sliding speed of the user by using a dynamic matching algorithm, thereby implementing precise pushing of the promotion content. This improves a matching degree between the promotion content and the interest of the user, so that the promotion content presented in the unit time better conforms to the user requirement, improves the utilization efficiency of the promotion resource, avoids ineffective promotion, and further improves a promotion conversion rate.

In some embodiments, in response to the sliding operation being triggered on the information flow interface, the linked promotion content matching the typesetting information is jointly displayed in the content positions in the region by sliding to at least two content positions in the current display region, and different typesetting information correspond to the linked promotion content of different types of objects. In the solution, the typesetting information is obtained by using a picture recognition technology, and adaptive linked promotion content is presented based on an information matching technology, so that layout of the promotion content on an interface is optimized. This not only enables integration of the promotion content and the information flow interface to be more natural and harmonic, thereby avoiding visual interference of the user caused by inharmonious typesetting, but also improves attention and acceptance of the user on the promotion content, and enhances the presentation effect of the promotion content.

In some embodiments, in response to triggering the sliding operation performed on the information flow interface, the new content position is continuously displayed and the content cover of the multimedia content is loaded. After the sliding operation is continuously triggered, the linked promotion content is jointly displayed through at least two content positions. This manner keeps an interaction manner the same as that of the multimedia content cover, and unifies operations of triggering browsing the content cover and the linked promotion content. By means of a continuous sliding monitoring and content loading mechanism of a system, learning costs of the user are reduced, browsing convenience of the user is improved, continuous experience of the user in a browsing process is improved, staying time of the user in the information flow interface is increased, and user stickiness of a platform is improved.

In some embodiments, when the display sequence of the local promotion contents in the at least two content positions is the same as the exposure sequence of the content positions, the exposure sequence of the content positions is obtained and the local promotion contents are sequentially displayed in the sequence to present the linked promotion content. This solution uses an orderly presentation policy, and conforms to a visual browsing habit and cognitive logic of the user. In technical implementation, by properly planning the presentation sequence, the user is facilitated to better understand and receive the promotion information, logic and continuity of information transfer are enhanced, understanding and acceptance of the promotion content by the user are improved, and an information spreading effect is improved.

In some embodiments, if the at least two content positions include the center content position and the outer content position, in response to that the promotion content presentation condition being met, the linked promotion content is gradually enlarged to occupy the outer content position after the linked promotion content is displayed in the center content position. In this solution, a dynamic expansion presentation technology is adopted, so that attention of the user can be focused and detailed information of the target object can be highlighted. In a technical layer, the dynamic adjustment of the presentation region enhances visual impacts and attractiveness of the promotion content, which can attract more attention compared to the static display, thereby improving the display effect of the promotion content and attractiveness to the user, and improving promotion effectiveness.

In some embodiments, if the at least two content positions include the first content position subset and the second content position subset, in response to the promotion content presentation condition being met, the linked promotion content is displayed in the first content position subset, and is gradually moved into the second content position subset. In this solution, a content position interaction technology is used, to implement interactive presentation between the content cover and the linked promotion content. This brings novel browsing experience to the user, increases attention and engagement of the user on the promotion content, improves interactivity between the user and the promotion content through a technical means, improves the display effect of the promotion content, and further improves the promotion efficiency and effect.

In some embodiments, if the linked promotion content points to the target content position, after the linked promotion content is presented, the user triggers the content cover of the target content position, the content interface including the multimedia content or the promotion content and the promotion link of the target object may be displayed, and then the promotion link is triggered to enter the detail interface. The solution provides the user with an additional and convenient way of entering the detail interface by using an accurate pointing recognition technology and an efficient interface jumping mechanism. This increases a speed at which the user obtains the detailed information of the target object, reduces operation steps of searching for information by the user, improves efficiency of a promotion process, and improves user experience, so that the user can obtain the information more quickly and accurately, and enhances a guiding effect of promotion content for the user.

In some embodiments, in response to the promotion content presentation condition being met, the static linked promotion picture is displayed in the information flow interface, and the static linked promotion picture is jointly formed by local promotion pictures in the at least two content positions. In this solution, the presentation area is expanded through a multi-content position combination presentation technology. Technically, the promotion content can be presented in a clear and stable image. Compared with presentation at a single content position, visual impacts are enhanced, attention of the user is more attracted, the propagation effect and the presentation effect of the promotion content are improved, the user is facilitated to more intuitively understand features of the target object, and an information transmission effect is improved.

In some embodiments, if the local promotion picture in each content position includes different promotion contents, an explanation video can be presented by triggering any local promotion picture. In this solution, a content association technology is used, to satisfy a requirement for obtaining personalized information of the user. By setting corresponding explanation videos for different local promotion pictures, the user can select to watch in a targeted manner based on a requirement of the user, to obtain more detailed information. This improves accuracy of information transmission, so that the promotion content can better satisfy requirements of different users, interactivity between the user and the promotion content is enhanced, and a degree of understanding of the target object by the user is improved.

In some embodiments, in response to the promotion content presentation condition being met, the dynamic linked promotion video is displayed in the information flow interface, and the dynamic linked promotion video is formed by combining local promotion videos in the at least two content positions. The solution uses video synthesis and multi-content position collaborative presentation technologies, and can present more abundant dynamic information compared with a single content position. The dynamic video can more vividly present features and use scenarios of the target object, and attracts attention of the user by using the dynamic image, thereby improving attractiveness and a propagation effect of the promotion content, so that the promotion content is more expressive, thereby helping improve cognition and interest of the user on the target object.

In some embodiments, the target linked special effect is performed on each content position occupied by linked promotion content, so that the local promotion contents interact with each other. In the solution, special effect synthesis and interaction technologies are used, so that the plurality of content positions occupied by the linked promotion content are combined with the same special effect. Through the visual impact of the special effects, the promotion content promotion creative is enhanced, attention of the user is effectively attracted, the click-through rate of the promotion content is increased, propagation efficiency and impact of the promotion content are improved, and attractiveness of the promotion content and user engagement are technically improved.

In some embodiments, the target linked element matching the target object is displayed on the linked promotion content in an overlay manner, and the target linked element is jointly formed by the local elements in the content positions. Through element superposition and cross-content position integration technologies, this solution implements that the target linked element intersects at least two content positions occupied by the linked promotion content. Through the element design matching the target object, interestingness of the promotion content is improved, attention of the user is attracted, the click-through rate of the promotion content is effectively increased, attractiveness and the propagation effect of the promotion content are improved, and a memory point of the user for the promotion content is enhanced.

In some embodiments, if each local promotion content of the linked promotion content presents different promotion content, the detail interface can be jumped to by triggering any local promotion content. By establishing a convenient content jumping mechanism, this solution implements full presentation of the target object and convenient jumping. This greatly facilitates user interaction, simplifies a process of obtaining information and performing an operation by the user, improves convenience of a promotion process, and enables the user to quickly and directly enter the detail interface from the local promotion content in which the user is interested, thereby improving the user experience and the promotion effect.

In some embodiments, the content position area occupied by the linked promotion content is related to the historical browsing frequency of the target object by the current login account, and a higher historical browsing frequency indicates a larger content position area. In this solution, the content position area is dynamically adjusted based on historical browsing data of the user. In this manner, a content position in which the user is interested can be highlighted, presentation of the promotion content is optimized, the attention degree of the user on the promotion content is improved, personalized allocation of the promotion resource is implemented, and promotion targeting and effect are improved.

In some embodiments, when at least two content positions are arranged in an irregular manner and the original promotion content image fails to be completely displayed, the content cover of the multimedia content is displayed in other content positions that are tightly filled around the at least two content positions. In this solution, an intelligent layout filling technology is adopted to ensure that there is no blank or unused space in the information flow interface, so that the content cover and the linked promotion content are seamlessly integrated. This improves interface aesthetics, provides rich, compact, and immersive browsing experience for the user, prevents the user from being abrupt or interfered during browsing, optimizes a browsing environment of the user, and improves overall browsing experience of the user on the platform.

In some embodiments, the operation of determining the linked promotion content is obtaining the promotion content and the content position information of the target object, constructing the mask layer, and superposing the mask layer to the promotion content. In this solution, the linked promotion content is flexibly designed based on an actual promotion requirement by using a mask layer construction technology and a content superposition technology. By constructing the mask layer through precise calculation of the region area and the quantity of content positions, the target object can be maximally presented based on the plurality of content positions, customization and adaptability of promotion content are improved, the promotion efficiency and the display effect of the promotion content are improved, executability of the promotion solution is enhanced, and a more flexible and efficient implementation is provided for a promotion activity from a technical level.

In some embodiments, the region area of the promotion content presentation region is determined based on the historical browsing frequency of the current login account in the information flow interface, and a higher historical browsing frequency indicates a larger region area. In this solution, the historical browsing data of the user is analyzed, the area of the promotion content presentation region is dynamically adjusted based on the historical browsing frequency, and the region area is enlarged for a user having a high probability of browsing the promotion content of a target object of a related type. This implements precise allocation and efficient utilization of the promotion resource, improves promotion efficiency of the promotion content while ensuring user experience, causes the promotion activity to be more targeted, and improves an overall promotion effect.

According to some embodiments of the present disclosure, the region area of the promotion content presentation region is determined based on the historical browsing frequency of the current login account in the information flow interface. The historical browsing frequency is a historical browsing frequency of another object by the current login account, a type of the another object being the same as a type of the target object, a higher historical browsing frequency indicating a larger corresponding region area.

The technical features of some embodiments may be combined in different manners to form other embodiments. To make the description concise, not all possible combinations of the technical features in the foregoing embodiments are described. However, the combinations of these technical features are considered to fall within the scope recorded in this present disclosure provided that no conflict exists.

Some embodiments only describe several implementations of present disclosure, which are described specifically and in detail, but cannot be construed as a limitation to the patent scope of present disclosure. For those of ordinary skill in the art, several transformations and improvements may further be made without departing from the idea of present disclosure. These transformations and improvements belong to the protection scope of present disclosure. Therefore, the protection scope of the patent of present disclosure shall be subject to the appended claims.

What is claimed is:

1. A method for promotion content display performed by a terminal, the method comprising:
displaying an information flow interface comprising a plurality of content positions, each of the plurality of content positions being configured to display a content cover of one multimedia content; and
displaying, through at least two of the plurality of content positions based on a promotion content presentation condition being met, a linked promotion content configured to promote a target object, each of the at least two of the plurality of content positions displaying a local promotion content of the linked promotion content.

2. The method according to claim 1, wherein the displaying, through the at least two of the plurality of content positions based on the promotion content presentation condition being met comprises:
displaying, through the at least two of the plurality of content positions based on triggering a sliding operation performed on the information flow interface, the linked promotion content configured to promote the target object.

3. The method according to claim 2, wherein the displaying, through the at least two of the plurality of content positions based on the promotion content presentation condition being met comprises:
displaying, through the at least two of the plurality of content positions based on triggering the sliding operation performed on the information flow interface, the linked promotion content that is configured to promote the target object, the linked promotion content matching a sliding speed of the sliding operation, different sliding speed ranges matching linked promotion contents configured to promote different types of target objects.

4. The method according to claim 2, wherein the displaying, through the at least two of the plurality of content positions based on the promotion content presentation condition being met comprises:
displaying, by sliding to the at least two of the plurality of content positions in a current display region based on triggering the sliding operation performed on the information flow interface, a linked promotion content that is configured to promote the target object, a linked promotion content matching typesetting information of the plurality of content positions in the current display region, different typesetting information being respectively configured to promote linked promotion contents of different types of objects.

5. The method according to claim 2, further comprising:
displaying new content positions in the information flow interface with a sliding direction of the sliding operation based on the sliding operation triggered on the information flow interface; and
displaying a content cover of a multimedia content in each new content position, the multimedia content being issued through a multimedia account,
wherein the jointly displaying, through the at least two of the plurality of content positions based on the promotion content presentation condition being met comprises:
displaying, through the at least two of the plurality of content positions based on the sliding operation continuously triggered on the information flow interface, the linked promotion content being configured to promote the target object.

6. The method according to claim 1, wherein a display sequence of local promotion contents respectively displayed in the at least two of the plurality of content positions is the same as an exposure sequence of the at least two of the plurality of content positions, and
wherein the displaying, through the at least two of the plurality of content positions based on the promotion content presentation condition being met comprises:
obtaining an exposure sequence of at least two of the plurality of content positions occupied by the linked promotion content; and
displaying, when a promotion content presentation is met, a corresponding local promotion content in each of the at least two of the plurality of content positions in the information flow interface based on the exposure sequence of the at least two of the plurality of content positions.

7. The method according to claim 1, wherein the at least two of the plurality of content positions comprise a center content position located in a middle position and an outer content position surrounding the center content position, and
wherein the displaying, through the at least two of the plurality of content positions based on the promotion content presentation condition being met comprises:
displaying that the linked promotion content in the center content position is gradually enlarged until the outer content position of the at least two of the plurality of content positions is occupied when the linked promotion content is displayed in the center content position of the at least two of the plurality of content positions based on the promotion content presentation condition being met.

8. The method according to claim 1, wherein the at least two of the plurality of content positions comprise a first content position subset and a second content position subset, and
wherein the displaying, through at least two of the plurality of content positions based on the promotion content presentation condition being met comprises:
displaying the linked promotion content in a content position in the first content position subset based on the promotion content presentation condition being met; and
displaying that the linked promotion content in the first content position subset is gradually moved from the first content position subset to a content position in the second content position subset.

9. The method according to claim 5, wherein the linked promotion content displayed in the at least two of the plurality of content positions points to a target content position, and
wherein, after the jointly displaying, through the at least two of the plurality of content positions based on the promotion content presentation condition being met, the method further comprises:
displaying a content interface corresponding to the content cover based on a triggering operation performed on the content cover displayed in the target content position;
displaying the multimedia content or the linked promotion content in the content interface, the content interface further comprising a promotion link of the target object; and
displaying a detail interface about the target object based on a triggering operation performed on the promotion link.

10. The method according to claim 1, wherein the displaying, through the at least two of the plurality of content positions based on the promotion content presentation condition being met comprises:
displaying a static linked promotion picture in the information flow interface based on the promotion content presentation condition being met, the static linked promotion picture occupying at least two adjacent content positions, local promotion pictures being displayed in each of the at least two of the plurality of content positions forming the static linked promotion picture.

11. The method according to claim 10, wherein a local promotion picture displayed in each of the at least two of the plurality of content positions comprises different promotion contents about the target object, and
wherein the method further comprises:
presenting an explanation video about the target object in the operated content position based on a triggering operation performed on the local promotion picture displayed in one of the at least two of the plurality of content positions.

12. The method according to claim 1, wherein the displaying, through the at least two of the plurality of content positions based on the promotion content presentation condition being met comprises:
displaying a dynamic linked promotion video in the information flow interface based on the promotion content presentation condition being met, the dynamic linked promotion video occupying at least two adjacent content positions, local promotion videos displayed in each of the at least two of the plurality of content positions being combined into the dynamic linked promotion video.

13. The method according to claim 1, further comprising:
performing a target linked special effect on each of the plurality of content positions occupied by the linked promotion content, the target linked special effect being an animation special effect enabling interaction of the local promotion content displayed in each of the plurality of content positions; and
displaying that the local promotion content in each of the plurality of content positions interacts with each other through the target linked special effect.

14. The method according to claim 1, further comprising:
displaying a target linked element on the linked promotion content in an overlay manner, the target linked element matching the target object, the target linked element being distributed in the at least two of the plurality of content positions occupied by the linked promotion content, local elements displayed on the local promotion content in each of the plurality of content positions in the overlay manner forming the target linked element.

15. The method according to claim 9, wherein each local promotion content in the linked promotion content is configured to present different promotion contents about the target object; and
wherein the method further comprises:
jumping to detail interface about the target object from the information flow interface based on the triggering operation performed on the local promotion content displayed in one of the at least two of the plurality of content positions occupied by the linked promotion content.

16. The method according to claim 15, wherein for each of the at least two of the plurality of content positions occupied by the linked promotion content, an area of a content position is associated with a historical browsing frequency of the target object by a current login account, a higher historical browsing frequency indicating a larger area of a corresponding content position.

17. The method according to claim 5, further comprising:
displaying a content cover of the multimedia content in other content positions that are tightly filled around at least two of the plurality of content positions based on at least two of the plurality of content positions being arranged in an irregular manner and the at least two of the plurality of content positions failing to completely display an original promotion content image.

18. The method according to claim 1, wherein determining the linked promotion content comprises:
obtaining a promotion content of the target object and content position information configured for presenting the promotion content, the content position information comprising a region area of a promotion content presentation region of the target object and a quantity of content positions of plurality of content positions configured for presenting the promotion content;
generating a mask layer based on the promotion content presentation region and the quantity of the plurality of content positions, the mask layer comprising a plurality of content positions arranged in an irregular manner; and
superimposing the mask layer onto the promotion content, to obtain the linked promotion content.

19. An apparatus for promotion content display, comprising:
at least one memory configured to store computer program code; and
at least one processor configured to read the program code and operate as instructed by the program code, the program code comprising:
interface presentation code configured to cause the at least one processor to display an information flow interface comprising a plurality of content positions, each of the plurality of content positions being configured to display a content cover of one multimedia content; and
content presentation code configured to cause the at least one processor to display, through at least two of the plurality of content positions based on a promotion content presentation condition being met, a linked promotion content configured to promote a target object, each of the at least two of the plurality of content positions displaying a local promotion content of the linked promotion content.

20. A non-transitory computer-readable storage medium, storing computer program code, when executed by at least one processor, causes the at least one processor to at least:
display an information flow interface comprising a plurality of content positions, each of the plurality of content positions being configured to display a content cover of one multimedia content; and
display, through at least two of the plurality of content positions based on a promotion content presentation condition being met, a linked promotion content configured to promote a target object, each of the at least two of the plurality of content positions displaying a local promotion content of the linked promotion content.
